(19) United States
(12) Patent Application Publication
(10) Pub. No.: US 2022/0316374 A1
(43) Pub. Date: Oct. 6, 2022

(54) REACTION AND DESIGN CONCEPT FOR ENGINES FOR CATALYTIC CONTROL / ERGETIC TRIGGERING (E.G. WITH METAL ADDITIVES) OF THE INTERNAL VELOCITY (ACCELERATION) AND EXIT VELOCITY WITH INFLUENCING OF TEMPERATURE AS WELL AS PRESSURE FOR IMPROVED 5 EFFICIENCY AND COMBUSTION CHAMBER ADAPTATION (TREIBER-CONCEPT)

(71) Applicant: Mathias Herrmann, Erfurt (DE)

(72) Inventor: Mathias Herrmann, Erfurt (DE)

(73) Assignee: Mathias Herrmann, Erfurt (DE)

(21) Appl. No.: 17/650,537

(22) Filed: Feb. 10, 2022

(30) Foreign Application Priority Data
Feb. 11, 2021 (DE) 10 2021 000 701.8

(51) Int. Cl. F01N 3/20; F02C 3/34

(52) U.S. Cl. CPC F01N 3/206; F02C 3/34

(57) ABSTRACT

System for chemical engine systems or air-breathing engine systems comprising: a catalytic combustion and/or addition of metallic additives, which can additionally adapt the combustion by homogeneous, respectively heterogeneous catalysts. The adaptation of combustion rate, combustion pressure, combustion temperature, latent heat and other conditions (e.g. heat reflections) can be used in a variety of technological ways. This enables optimization of combustion chamber geometry and, for example, reduction of profile losses. Lossy energy conversions are to be minimized, or specifically adapted (e.g. to a variable ambient pressure during vertical starts). To protect the adapted combustion, methods are named to avoid e.g. fouling, aging of the reactive surface, destructive pressure shocks and especially thermal damage. The potential through further technological additions, e.g. by means of contactless ignition or superordinate process concept is pointed out.

### CROSS REFERENCE TO RELATED DOCUMENTS

The present application claims priority to provisional patent application number DE 10 2021 000 701.8 filed on Feb. 11, 2021 in Germany, disclosure of which are intercorporated herein at least by reference.

### Non Patent Literature

[1] Prof. Dr. Erwin Riedel et al: Anorganische Chemie, 6. Auflage (2004), TU-Berlin, Verlag de Gruyter, ISBN 3-11-018168-1
[2] https://www.iom-leipzig.de/forschung/praezision-oberflaechen/
[3] Dipl.-Ing. Alexander Matthias Seidel: Entwicklung eines technischen Platin-Tragerkatalysators zur Dehydrierung von Perhydro-Debenzyltoluol (Dissertation), 30 Oct. 2019, Friedrich-Alexander-Universität Erlangen-Nürnberg
[4] A. G. Knapton: Alloys of Platinum and Tungsten; Platinum Metals Rev. 1980 24 (2); 64-69; Group Research Centre, Johnson Matthey & Co Limited
[5] D. P. Harmon: Technical Report NO. AFML-TR-66-290-FINAL REPORT, Oktober 1966, Aerojet-General Corporation
[6] Ernst Messerschmid et al: Raumfahrtsysteme; 4. Auflage, 2011, ISBN 978-3-642-12816-5
[7] Wilfried Ley et. al.: Handbuch der Raumfahrttechnik; ISBN 978-3-446-45429-3; 2019, Carl Hanser Verlag München
[8] https://www.dlr.de/wf/desktopdefault.aspx/tabid-2131/2303_read-5317/ from 25 Jan. 2022
[9] https://ultramet.com/propulsion-system-components/liquid-rocket-engines/
[10]haps://www.enargus.de/pub/bscw.cgi/d8614-2/*/*/Photokatalyse.html?op=Wiki. getwiki from 25 Jan. 2021
[11] Apogee: Terminology Of Model Rocketry; ISSUE 321, Sep. 11, 2021
[12] Xiaofeng Yan (Dissertation): Numerische Simulation und Zeitskalenanalyse katalytischer Verbrennungsprozesse; 13 Mar. 2001; Universität Stuttgart
[13] Kurt Eckerstorfer (Masterarbeit): Auslegung und Konstruktion eines Prüfstands zur katalytischen Umsetzung von Wasserstoff; TU-Graz; August 2015
[14] Dipl.-Ing. Matthias Endisch (Dissertation): Experimentelle und numerische Untersuchungen zur stabilen Entsorgung von Schwachgasen in porösen Verbrennungsreaktoren; 8 Feb. 2013; TU Bergakademie Freiberg
[15] Tomasz Palacz: Nitrous Oxide Application for Low-Thrust and Low-Cost Liquid Rocket Engine; AGH Space Systems
[16] Saxena Samveg (Dissertation): Maximizing Power Output in Homogeneous Charge Compression Ignition (HCCL) Engines and Enabling Effective Control of Combustion Timing; University of California 2011
[17] Dipl.-Ing.; Neda Djordjevic: “Flammenstabilisierung durch Verbrennung in festen Schwämmen”; TU-Karlsruhe; 14 Jan. 2011

### BACKGROUND OF THE INVENTION

### 1. Field of the Invention

The present invention relates to the field of aerospace, including the optimization of catalyst use, combustion and combustion chamber, and relates more particularly to methods and devices for optimizing chemical combustion.

### 2. Discussion of the State of the Art

The present invention relates to the field of aerospace, including the optimization of catalyst use, combustion and combustion chamber, and relates in particular to the provision of large amounts of energy in a relatively short time, e.g. to travel from Earth to Earth orbit or further space. In particular, the Earth's gravitational field, air resistance and energy losses (e.g. due to dead loads, losses during energy conversion) have to be overcome. For the delivery of payloads into Earth orbit and further space (e.g. for satellites, spacecraft, transport cargo), chemical rocket engine systems are in use according to the current state of the art. The performance of chemical thruster systems is limited by the underlying chemical reaction and its technical lossy energy conversion. The reaction partners in the engine system are converted as completely as possible in just a few minutes. In this process, the propellant can comprise about 90% of the total starting mass. Chemical energy is predominantly converted into thermal energy and then, if possible, into kinetic energy. In the process, the energy is partially radiated (heat), converted into latent heat and friction of the missile. In large engine systems, about 2% of the chemical energy expended for thrust is lost through thermal jet losses, and in small engine systems, about 29%. Due to further kinematic jet losses, for example, about 25% of the chemical energy expended for thrust is lost in a small engine system (rocket). After deduction of further losses, typically 40-70% of the expended power is available (from supplied chemical energy). This quantifies the actual thrust of chemical rocket engine systems [6]. f Methods and devices for optimizing chemical combustion.

In order to travel, for example, from the Earth into orbit or further space, the provision of large amounts of energy in a relatively short time is required. In particular, the Earth's gravitational field, air resistance, and energy losses (e.g., due to dead loads, losses during energy conversion) must be overcome. For the delivery of payloads into Earth orbit and further space (e.g. for satellites, spacecraft, transport cargo), chemical rocket engine systems are in use according to the current state of the art. The performance of chemical thruster systems is limited by the underlying chemical reaction and its technical lossy energy conversion. The reaction partners in the engine system are converted as completely as possible in just a few minutes. In this process, the propellant can comprise about 90% of the total starting mass. Chemical energy is predominantly converted into thermal energy and then, if possible, into kinetic energy. In the process, the energy is partially radiated (heat), converted into latent heat, and friction of the missile. In large engine systems, about 2% of the chemical energy expended for thrust is lost through thermal jet losses, and in small engine systems, about 29%. Due to further kinematic jet losses, for example, about 25% of the chemical energy expended for thrust is lost in a small engine system (rocket). After deduction of further losses, typically 40-70% of the expended power is available (from supplied chemical energy). This quantifies the actual thrust of chemical rocket engine systems [6].

Catalysts can exert an influence on chemical processes. Several theories are in circulation on the mode of action. It is described that catalysts form highly reactive radicals. Another theory involves the influence of certain electromagnetic radiation and catalysts or chemical reactions. This photo-catalytic effect is explained in [9]. In general, processes with catalysts are already predominantly used in the chemical industry to increase the economy, energy efficiency and yield per reaction (about more than 80% of chemical processes with an increasing tendency). It should be emphasized that catalysts thus reduce emissions (e.g. H₂O or CO₂), reduce pollutants (possibly CO or NOR), increase the burnout of the reactants and above all the energy efficiency. At the same time, depending on the reaction, an increase in performance, operational reliability and service life can be achieved. This further contributes to the environmental balance.

According to current knowledge, catalysts primarily reduce the required activation energy by bridging the bonds in the reaction partners. Depending on the reaction, different catalysts are used in varying conditions (or accompanying promoters, etc.). The development and optimization of catalysts is an incompletely exploited future field of technology. This future field has a not yet assessable potential, also in the engineering field of the fundamental design. This concept provides concrete approaches to this. The payload share of the total launch mass achievable so far for low Earth orbit is limited in the lower percentage range. Therefore, an increase in performance of propulsion systems is advantageous to achieve good, respectively effects for space mining, respectively space colonization and to advance a further industrial wave.

The chemical reaction rate is generally limited, but can be increased in the presence of suitable catalysts. The use of catalysts is particularly feasible in newer propulsion concepts, such as air-breathing engine systems (ramjet, scramjet, multimode, pulse jet engine). The influencing parameters in these engine systems are sometimes subject to considerable fluctuations. Short fuel residence times and air mass flow rates also justify the use of catalysts. The use of catalysts represents a possible optimization of oxidizer or propellant burnout. In rocket engine systems, although the reaction is already nearly complete through ongoing optimization, it can be adapted for further energetic effects. Also, further use of catalysts in aerospikes, or advanced nozzle concepts is beneficial to overcome thermal challenges.

Thus, catalysts can be used not only to lower the required temperatures in endothermic reactions, such as the Haber-Bosch process, but also to increase the yield. Comparable results can also be achieved in exothermic reactions, or combustion, with modified process conditions such as reaction times, combustion temperatures or pressures. For example, [12] states that suitable catalysts can achieve higher reaction rates at the same temperature. For aero gas turbines, the temperature can be reduced by more than 1,000 K by means of sub-stoichiometric combustion compared to stoichiometric combustion. In principle, stoichiometry in chemical engines is not always uniformly distributed in the combustion chamber. To improve the heat balance and thrust, for example, some rocket engine systems burn more fuel near the wall.

In, order to make it easier to identify the concept, the following concept is referred to as the Treiber concept for driving the chemical reaction in the desired direction. In other words, the engine systems are to be operated in an extended range of applications with the greatest possible safety. The goal is to effectively support the Heber concept (File number DE 10 2021 004 807.5) under the changing operating conditions, e.g. also by providing the desired earliest possible power readiness in a cold start scenario. In summary, the Treiber concept makes use of the property of catalysts to cause an explosive conversion of hydrogen and oxygen (oxyhydrogen reaction), but also methane and oxygen, even under reduced ambient temperature. Combinations with other reaction partners are also possible.

This patent application contains a concept for possibilities in catalytic combustion of chemical engine systems as a basic technology. Another basic technology filed by the applicant of the same name is contactless electromagnetic ignition and combustion stimulation (File number DE 10 2021 001 272.0). This basic technology was named “Combustion and ignition concept”. “In the adapted process concept” (File number DE 10 2021 004 141.0) of the applicant with the same name, on the other hand, the higher-level possibilities of both basic technologies are combined in a variable and complementary manner.

State of the Art of Catalysts

Catalysts consist of one or more catalytic substances (e.g. platinum) and can be supplemented and reinforced by promoters/stabilizers and co-catalysts (e.g. palladium), etc. Catalysts are differentiated according to the path of action into heterogeneous catalysts (separate phase to reaction partner) and homogeneous catalysts (together in phase with reaction partners, e.g. liquid). A basic distinction is also made between primary catalysts (arranged upstream of or in the combustion chamber) and secondary catalysts (arranged downstream of the combustion chamber for further exhaust gas purification). The following explanations refer exclusively to primary catalysts, since these are decisive in the aerospace sector.

Mainly catalysts made of elements of the platinum group and noble metals are used (e.g. gold). The use of different elements can lead to an increase in catalytic activity (see, for example, patent specification DE 600 16 706 T2). Even small traces of catalysts can have a significant effect on the process. For highly effective homogeneous catalysts (e.g. noble metals such as platinum), even millionths or billionths of a mass of catalyst are typically sufficient for the fuel (DE 600 16 706 T2). In the case of highly effective heterogeneous catalysts, layer thicknesses of only a few thousandths of a millimeter may be sufficient (depending, for example, on process conditions). Descriptions are contained in patent specification DE 195 00 997 C1.

Catalysts have been manufactured and used for many years. Patent specification GB00000153113A4 (Jan. 11, 1978) publishes on the forming of sheet metal and explains how sheet metal is rolled up in ZigZag to produce catalytic bodies, for example.

In the field of chemical engine systems, processes with catalysts are already partly in use and are the subject of increasing research. This applies to both air breathers and rocket engine systems. Usually, hydrogen and oxygen, methane and oxygen, or longer-chain hydrocarbons (e.g. kerosene/RP1) are used as reaction partners in liquid propulsion systems. Platinum is generally preferred as the catalyst.

To increase thrust and keep the materials of the combustion chamber in the permissible thermal and material-compatible operating mode, fuel components are predominantly burned in a non-stoichiometric ratio (fuel-rich). Oxygen reacts very aggressively, especially at high temperatures and in radical form.

Heterogeneous Catalysts

Up to now, heterogeneous catalysts have generally been installed upstream of the combustion chamber (e.g. as catalyst beds), or have not been integrated into the combustion chamber. This allows recombination of the individual starting products, e.g. recombination of H to H₂. In this process, the catalytic effect is partially consumed again, depending on the injection conditions (pressure, temperature). A single exception is contained in a patent specification (US 0000 0354 5879 A of 18 Jan. 1969). Here, discs of catalyst material in the combustion chamber defined by silver or nickel doped with rare earths (e.g. samarium) with small passages were developed. Since this technical solution is described as permissible up to a maximum combustion chamber temperature of about 200 980° C. (or 1,800° F.), hydrazine (H₂O₂) and hydrogen peroxide (N₂H₂) are specified as propellants. The application is designed for both mono- and bipropellant, or monergole/digole. However, these propellants are technically delicate, or highly toxic.

Patent specification US 20200049103A1 for aerospikes covers Rocket Propellant 1 (RP1) and catalysts made of potassium permanganate. The catalysts are primarily composed of aluminum foam (aluminum oxide) impregnated with potassium permanganate. In a secondary stage, aluminum ceramic pellets saturated with potassium permanganate are captured.

According to patent specification DE 602 03 315 T2, platinum/rhodium catalysts, for example, are particularly suitable for the reaction of steam and methane (steam reforming). For the reaction of hydrogen and oxygen, or hydrocarbons, platinum catalysts are common. According to patent specification DE 195 00 997 C1, a platinum layer thickness of 0.05 to approx. 0.09 μm is already sufficient for this purpose, at lower reaction temperatures.

Patent specification US 0000 3407,604 describes the use of heterogeneous catalysts in rocket engine systems for oxygen and hydrogen. The technical feasibility of rhodium and platinum-rhodium catalysts is explained. According to this, stable ignition temperatures up to the range between −50° C. and −253° C. and combustion temperatures with 1,100° C. and higher are realizable. Combustion chambers with catalyst bodies with maximum specific surface area are preferred for this purpose. For the heterogeneous catalysts, the described base material of metal oxides exhibits specific surface areas of in some cases well over 100 m²/g. The entire cross-section of the combustion chamber is used. The design of the combustion chamber with the Laval nozzle itself is not the subject of invention of this historical patent specification.

In contrast, the increased reaction of hydrogen and oxygen, or methane and oxygen, causes higher temperatures in the combustion chamber. Thus, this technical solution is not sufficiently suitable for today's main propulsion systems in continuous operation.

Various patent specifications state the appropriate use of heterogeneous catalysts for Ramjets and Scramjets in the fuel/cooling system (e.g. U.S. Pat. No. 8,882,863 B2, US 2008 0257146 A1).

According to patent specification DD 77961, it is alternatively possible to increase the activity by an order of magnitude. The catalysts are to be treated in advance by high-energy ions.

Partial work is being done on catalyst beds for rocket engine systems (e.g. patent specifications EP 0 0000 3128 165 A1 or US 2013 0205 754 A1). Catalyst beds are more suitable for smaller propulsion systems and monopropellants/monergols (due to flow resistance, among other things). Therefore, these systems are used in particular for pulsed combustion, controlled by valves (e.g. patent specification US 2009 0120 060). Patent specification US 2013 0205 754 proposes a catalyst bed with iridium, platinum, rhodium, tungsten, copper, cobalt, or even gold for hydrocarbon-containing fuels. “Embedded triggers” (imbedded triggers) mixed in the percentage are proposed for catalytic properties of the fuel itself, prior to reaction with the oxidizer (e.g., in RP1: N2O/N2O4). However, unlike catalysts, these substances react themselves and are consumed. In this regard, reference is also made to patent specification US 2016 0176 771 A1.

Homogeneous Catalysts

In general, the homogeneous catalyst can be brought into suspension as particles, or added finely distributed as powder. Alternatively, fine fibers/fiber bundles are possible, for example.

According to patent specification DE 600 16 706 T2 published on Jan. 19, 2006, the homogeneous introduction of a mixture of metals into the flame zone of a combustion chamber for vehicles is covered. The metals consist of platinum, rhodium, rhenium and molybdenum. The aim is to achieve more complete combustion of the fuel while avoiding endothermic reactions (e.g. reduced formation of toxic nitrogen oxides). It should be noted that rhodium is classified as a toxic substance, including its aerosols. However, the dosage indicated in the invention is very low. The invention relates to fuels and their combustion by air injection, as well as specific mixing ratios of platinum, rhodium, rhenium and molybdenum. For injection, the vapor transport into the combustion chamber, mixing into fuel and/or air is detected. According to the indicated embodiment of this patent specification, considerable improvements in fuel efficiency of about 12-48% are possible for the selected motor vehicles.

Patent specification US 2005 0044 778 A1 describes the addition of additives to fuels, including trimethoximethylsilanes in jet engines, or in aviation. The patent specification describes the improvement of the efficiency of hydrocarbon-containing fuels through additives. Among other things, additives of alkali and alkaline earth metals are proposed for this purpose.

The patent specification US 2011 0154 726 A1 (or US 2009 0056 207A1)—COMBUSTION MODIFIER AND METHOD FOR IMPROVING FUEL COMBUSTION covers the addition of metallic additives to hydrocarbon-containing fuels. This includes iron-containing or cerium-containing organometallic compounds. According to this patent specification, this reduces the residues remaining in the interior and other relevant surfaces from combustion and ignites the fuel earlier. As a result, the measured fuel consumption in the example given was reduced by about 40%, and at the same time the ratio of atmospheric oxygen to fuel increased, indicating more complete combustion. It was concluded that without catalytic converters, the combustion residues in the interior limit, or slow down, combustion. The ratio of additive to fuel was a maximum of 3 g per 20 gal (75.71) or the equivalent of about 1 gadditive per 25 l of fuel.

Patent specification WO 0019 9500 4119 A1—FUEL ADDITIVES points out that iron, manganese and copper as homogeneous catalysts can potentially cause damage to automotive engine systems. Therefore, alkali/alkaline earth, rare earth metals are preferred for this purpose. The aim is to increase the burnout of the fuel.

According to patent specification US 2018 0298 846 A1, pressure surges occurring in the engine cause possible temperature fluctuations at the catalytic converter. Damage can be caused to the engine itself. This shortens the service life of the engine. Therefore, according to this patent specification, further measures are required at the start of operation.

In the rest of the technical field, reference is also made to other catalyst materials. Similar conditions with endothermic reverse reaction exist e.g. in batteries or for the production of hydrogen from fuels. The catalysts used consist, for example, of niobium, zirconium, tungsten or molybdenum (patent specification US 2009 0123 360 A1). The material is generally described as elemental, compound, or alloy of these and other metals, or transition metals. Further concretization is missing. The dissociation of hydrogen (reverse reaction) in a fuel cell with a second catalyst of about 50 elements is also covered in the claims (also e.g. Pt, Mo, Re, W, Ps and Ir). However, this description does not include a description of a specific alloy, or reference to the exothermic reaction of hydrogen.

In another technical area for combustion chambers in combination with turbochargers, several reaction chambers are preferred according to patent specification WO 0020 1009 8746 A1 “SYSTEMS AND METHODS FOR PROVIDING A CATALYST”. These are connected in series. In some cases, a parallel inflow occurs to increase the pressure surges of the reaction. This approach represents an attempt to achieve the highest and most reacted mass flow rates possible. This requires a more comprehensive system, with additional space or external structural requirements. The components of the catalysts are generally designated from the periodic table as Group I, II, IVA, VI, VII, VIII elements, perrhenic acides, metaperrhenates, carbonyls, halides, and any combinations thereof. Platinum group metals are thus generally included. Group VI includes tungsten, and Group VII includes rhenium. The aforementioned patent is bound to the geometrical conditions of a multi-chamber structure. The catalysts are used for the working pressure of the system.

Patent specification US 0000 0327 2879 A covers catalysts for hydrocarbon-containing fuels as Lewis acids with Friedel-Crafts catalysts of the form HMeXn. Metal-containing ions are introduced which simultaneously have a catalytic effect.

According to patent specification US 0000 0660 2067 B1 METHOD FOR IMPROVING FUEL EFFICIENCY IN COMBUSTION CHAMBERS, the efficiency of hydrocarbon-containing fuels can be increased by adding an ionizable metallic component (e.g. chlorides, oxides, hydroxides and hydrates). The metallic component contains gold particles. Combustion will be more complete and the formation of hazardous byproducts will be reduced. The suggested concentration of gold is only 0.15 to 225 μg_{gold}/kg_{fuel}, the optimum is reached at 10-20 μg_{gold}/kg_{fuel}. For example, hydrogen tetrachloroaurate HauCl₄.H₂O can be used. The stated improvement in fuel efficiency is only about 3%. The reduction in pollutant emission is in some cases almost 50% (NOₓ emission).

Other catalysts contain e.g. cobalt oxide, copper oxide, tungsten oxide, or nickel and iron.

Some inhaled homogeneous catalysts can also be toxic, or are suspected of being toxic to living organisms (e.g. iridium-osmium mixture, osmium). Osmium is also one of the most expensive elements.

The patent specification U.S. Pat. No. 7,635,461 B2 COMPOSITE COMBUSTION CATALYST AND ASSOCIATED METHODS from 22 Dec. 2009 technologically describes fine metallic particles of combustible core, further oxidic and catalytic coatings. These are generally intended for propellants, but also explicitly for ramjets and scramjets. The particles have a maximum size ≤1 μm. Combination with heterogeneous catalysts is not envisaged.

For solid propellant systems, patent specification GB 00000 1252 497A from 1969 describes the metallic addition to solid propellants for rockets and Ramjets. Powdered additions of Be, Mg, Al, Zr or boron are proposed. In addition, other compounds of other metals, such as Li, Na, K, Al, Mn, Zn, or compounds containing iron/nickel/cobalt are proposed.

For solid systems, reaction-specific pressure exponents are also common-named “n”

### 2.1 Disadvantages of the State of the Art

In principle, chemical thruster systems involve lossy energy conversions. According to [6], typically 40-70% of the chemical energy expended can be used for actual thrust. The efficiency losses of 30-60% are to be reduced.

Although temperature is used to increase the reaction and the exit velocity at the engine, it cannot be shielded from pressure, for example, by walls. Among other things, this prevents heat radiation or conduction. However, latent heat is an exception. In the case of transition from solid phase to gaseous phase, two phase change enthalpies may be required (enthalpy of fusion and enthalpy of vaporization). Potentials from this through additions for cooling and kinematics (volume expansion) have not yet been fully exploited.

Catalysts reduce the activation energy of chemical reactions. Catalysts can be used for 2 main functions (indirect/direct). Catalysts can directly contribute to the decomposition of the starting products into smaller higher reactive components (both endothermic and exothermic), or accelerate the combustion process of the reaction of the starting products themselves. In this regard, patent specification US 0 2019 0209 997A1 states. Indirectly, in addition to increasing the yield, catalysts can also lead to a change in the reaction temperature and pressure. The latter in particular is not yet targeted in the prior art.

Currently, catalysts are not/or not used for decisive combustion chamber optimization in liquid fuels. The patent specification US 0 2019 0209 997A1 elaborates on supersonic combustion by means of advance catalytic reforming of the propellants. However, this patent specification does not include optimization of the combustion chamber, e.g., in subsonic rocket engines. Nor does it include optimization of supersonic engines themselves by maximum use. However, the current state of the art does not fully exploit the reactivity of existing chemical propulsion systems in some cases, since the energetic adaptation of the combustion chambers/combustors is lacking. However, thrust is a product of mass and acceleration. The highest possible acceleration is also dependent on the chemical reaction. High operating temperatures in the combustion chambers and thrusters can lead to increasing energy losses, additional binding of energy by dissociation of the molecules [6], thermo-mechanical stresses or heat stress in the material. The results are a shortening of component lifetime and further effort for cooling. In addition, materials with appropriate heat resistance are expensive and complex. Free reactants (radicals) that have not yet reacted are very reactive and attack the engine (e.g. oxygen). According to [6], individual combustion centers in the combustion chambers lead to oscillations in temperature and, above all, pressure. This results in malfunctions. There is also a risk of uneven combustion and deflagration due to incompletely ignited fuel. The risk of destructive pressure surges is increased. Unacceptable temperature fluctuations in the engine can also result.

In addition, catalysts must be protected against contamination and thermal or mechanical damage. Patent specification US 0000 3407,604 of 1968 omits decisive statements in this regard.

According to US 2013 0205 75 A1, catalyst beds upstream of the combustion chamber can cause spontaneous decomposition of the propellants (e.g., from Rocket Propellant 1—RP1)—possibly generating uncontrolled heat and adversely affecting the reaction.

High thermal requirements exist for performance-enhanced nozzle concepts. These include aerospikes in particular, or weight-reduced bell nozzles. Aerospikes cannot yet be successfully realized with high-temperature/high-performance propellants in continuous operation (e.g. O₂/H₂; CH₄ and O₂). The concentrated heat input at the nozzle throat requires additional measures. In general, however, a high combustion temperature is aimed at in order to maximize the exit velocity at the nozzle. However, this is limited, e.g. by heat resistance, and energetically lossy (especially for smaller nozzles). Conversely, using catalysts under elevated temperatures is desirable because catalytic activity increases with increasing temperature [3]. High-temperature catalysts are powerful, but not widely used in the combustion chamber.

According to [1], the surface texture is an important influencing factor for the chemical activity of the catalysts. For example, platinum can absorb and interact with hydrogen many times its volume due to a fine, partially diffuse microstructuring. In numerous patents and writings, the surface properties of the catalysts are not discussed at all or only in a subordinate manner. For example, the particle size is sometimes discussed in the case of powdered homogeneous catalysts. For homogeneous catalysts, a reduced grain size means an increase in specific surface area per volume of catalyst material. In one example, reference was made to the addition of particles <10 μm in fluids (patent specification US 2005 0070 431 A1). In [3] it is stated about technological improvements of platinum catalysts depending on surface properties. It is pointed out that increasing pore volumes have a positive influence on catalyst activity. On the other hand, an excessively high proportion of edge/corner atoms can render the catalyst ineffective due to excessive adsorption of the reactants (fouling effect). Flat terraces at the atomic level, on the other hand, are catalytically favorable. However, the fraction of edge/corner atoms (resulting fouling effect), which is to be evaluated negatively, refers to a structure size in the nanometer range [3]. In the context of this patent specification, a “moderate” roughness in the millimeter range (substrate of the coating, or basic structure e.g. as a sponge) and mycrometer range (coating) is evaluated as advantageous. The specific surface area and mass transfer by edge flow are increased. Various mechanical and electromagnetic processes are described for this purpose.

The inlet temperature of the reactants increases the reactivity. The working temperature of the catalysts and, in part, their possible cooling form the benchmark. Higher inlet temperatures of the reaction partners mean, for example, an earlier dissolution of the molecular bonds associated with higher reactivity.

Patent specification US 2003 0074 887, for example, describes cooling of a catalyst bed (upstream of the combustion chamber) through a bypass with 5% of the material to be decomposed. If the combustion chamber is divided into several catalytic reaction chambers, or upstream catalyst beds, additional effort is required. This results in energy losses and a reduction in the achievable mass flow. This limits the performance of the engine.

Patent specification EP 3591 210 A1 on Ramjets describes metallic particles that are incorporated in a reactive cooling system. Thermal dissociation is to be promoted in the fuel before injection. However, this is partly counteracted by the limited contact time in the cooling area and the distance to the combustion chamber.

Even before the melting temperature of the catalyst is exceeded, near-surface phase formation (liquid+solid) and degradation of the catalytic surface effectiveness, or its sintering/melting, can occur. Due to the high combustion temperatures in hydrogen-oxygen engines (or methane-oxygen engines), integration of the heterogeneous catalyst into the combustion chamber at high temperatures in continuous operation has not been known to date. Although the combustion temperature increases the exit velocity of the engine, the material/cooling requirements are also increased. This ultimately results in heat losses of the propulsion system and required changes in mass flow for lossy energy conversion. Catalysts are therefore energetically useful for increased conversion and an increase in the exit velocity.

The dissolution of the molecular bonds of the reactants occurs in contact, or proximity to the catalysts, as the atoms react in interaction with the catalyst. In this regard, the patent specification US 0 2019 0209 997A1 states with an intended reformation of the fuels during reactive cooling. However, if the catalyst and combustion chamber are spatially separated, the catalytic range is exceeded, or at least the catalytic effect is reduced (e.g., in the case of catalytic feed lines upstream of the combustion chamber). This applies in particular to start-up conditions, or the technical running-in of the catalytic converter. The ideal working temperature of the catalyst is not reached before the run-in period. This influences the combustion process in the engine.

Particularly because of the aggressiveness of the oxidizer, combustion is often not carried out in the stoichiometric ratio of the reactants (e.g. near the combustion chamber walls). In some cases, however, non-stoichiometric combustion also leads to higher thrust. In air-breathing engine systems (e.g. ramjets and scramjets), heterogeneous catalysts have not yet been used in the combustion chamber. In the patent specification EP 2 475 859 B1 RALEIGH-TAYLOR ASSISTED COMBUSTION AND COMBUSTORS ADAPTED TO EXPLOIT RAYLEIGH-TAYLOR INSTABILITY FOR INCREASING COMBUSTION RATES THEREIN, catalysts arranged vertically in a transversely accelerated flow for Ramjets are described.

In particular, the combination of heterogeneous and homogeneous catalysts represents a promising approach to minimizing the above-mentioned disadvantages at reasonable cost. Further effects are to be achieved. Fouling on heterogeneous catalysts is to be reduced. However, there are no other patent references for this. This can be countered by means of homogeneous catalysts. The homogeneous catalysts can be used at the same time for contactless electromagnetic ignition and stimulation of combustion in order to achieve energetically increased combustion (see also patent application DE 10 2021 001 272.0 of the applicant with the same name).

For solid systems, it is difficult to make decisive statements on the pressure exponents of catalysts with regard to knocking and ringing intensity. One possible reason is the partially dynamic combustion. If the binder and energetic material are bonded, poor burnup and non-uniform detachment can occur. Liquid fuels, however, allow a more uniform introduction and reaction in the combustion chamber.

### SUMMARY OF THE INVENTION

The purpose of the invention is to increase the efficiency of chemical engine systems.

In addition, the service life and operational reliability are to be increased. The use of catalysts on the turbopump generators is intended to improve performance during startup and control operation. At the same time, the strength of the materials can be maximized through reduced temperature development.

Additional modes of operation are possible. Spatial control of combustion is feasible through appropriate placement of the catalysts. In addition, an accelerated and as complete as possible reaction is facilitated. The specific efficiency of the combustion chambers as mass (=dead load) is increased. Cooling requirements can be reduced. Particularly in the starting phase, a higher thrust can be advantageous in order to accelerate the total starting mass as much as possible.

For air-breathing propulsion systems, one task of the invention is to achieve combustion that is as complete as possible in order to reduce fuel consumption-combined with minimal flow/pressure losses. The reaction is to decay prematurely and unburned intermediates/residual components/residues are to be further reduced. This will reduce premature degradation of the engine and stabilize the operating mode, while at the same time/aiming at an increase in operational safety. Furthermore, combustion at lower temperature and shorter reaction time shall lead to higher exit velocities and pressures.

With a view to achieving an engine system that is as fully reusable as possible, e.g. for outbound/return flights to Mars, while at the same time maximizing operational safety, catalysts are an interesting technical supplementary option. A higher reaction speed also reduces the losses caused by the Earth's gravitational field. This is because the flying object has to be held against the acceleration due to gravity for less time before a stable orbit can be achieved.

Solution of the Task

The following energetic variants are used to solve the task (efficiency increase):

[1] combustion at reduced combustion temperature

[2] increase of pressure or impulse in the engine

[3] Combustion with higher mass flow rate

[4] Combustion with increased temperature

[Variant 1] Combustion at Reduced Combustion Temperature.

Reduced temperature combustion can reduce thermal losses. Thermal jet losses can be about 25% of the chemical energy expended in some chemical engines [1].

For example, in lean premix combustion, temperatures can be regulated and combustion temperature reduced in combination with multistage combustion [8]. For this purpose, the combustion chamber can be staged in different ways, e.g. by combining heterogeneous and homogeneous catalysts.

Thus, according to the state of the art, a fuel-rich mixture is already used in combustion chambers at the edge in order to limit the temperature near the wall. This stoichiometric gradient is taken into account further in the following near the wall. The reason is that oxygen-rich combustion is associated with high chemical aggressiveness in the engine. However, if the combustion temperatures are lowered by this concept, relief can result.

An upstream heterogeneous catalyst, which converts the average mass flow leanly or proportionally, is therefore a suitable solution. Precombustion is carried out on this catalyst with as few internals as possible in the mass flow. On the downstream side, further combustion can be carried out, for example, by means of homogeneous catalysts injected downstream of the catalyst and, if necessary, additional injected mass flow. Alternatively, additional staging can be applied during further development. In this way, the reactions in the engine can be further regulated if necessary. This may be promising for the nozzle area.

In addition to this combustion, the average combustion temperature can also be adjusted in general by high catalytic activity (quality, or quantity/freight). However, it is important that uniform mixing takes place [13] and that heat conduction (recirculation) into the upstream fuel mass flow is limited. Otherwise, partially superadiabatic conditions may result [14] [17] according to [Variant 4]. Homogeneous catalysts in particular can be used for [Variant 2], since these do not have any heat conduction via solids. Alternatively, heterogeneous catalysts with limited thermal conductivity or insulation layers are also advantageous.

[Variant 2] Increasing the Pressure or Impulses in the Engine:

To further increase thrust, the pressure ratios of the combustion chamber and nozzle outlet can be adjusted. Combustion rate and combustion pressure are influenced by appropriate catalysts.

Higher combustion pressures can generally lead to destructive pressure fluctuations. In order to avoid corresponding “knocking” or “ringing”, further measures are therefore noted:
Knocking agents such as addition of alcohol (solution of homogeneous catalysts in alcohol); or water.
Division of the combustion chamber into sections,
Reduction of the respective ignition volume e.g. by larger number of nozzles.
Maximum homogenization of the mixture in the combustion chamber,
Use of different catalysts

[Variant 3] Combustion with Higher Mass Flow:

Catalysts can increase the conversion rates, or reaction rates.

Combustion chamber volume and mass flow for digols are determined with the following formula [14]:

Thus, the optimal combustion chamber volume V_{c} is:

Vc=Δt*\dot{m}/ρc

Δt—residence time in combustion chamber

ρc—density in combustion chamber

V_{c}—chamber volume

\dot{m}—fuel mass flow rate.

Catalysts accelerate the reaction and shorten the required residence time in the combustion chamber. This means that when catalysts are used, either the mass flow can be increased or the combustion chamber volume can be reduced. To reach the critical Mach number at the nozzle throat as early as possible, the injected fuel mass flow must be increased. This means that a higher velocity in the combustion chamber is energetically advantageous or desirable. This is because the further lossy acceleration required at the nozzle throat is inversely reduced as a result. Consequently, the constriction can be reduced.

As a result, this allows a higher further acceleration in the supersonic range of the diverging nozzle following downstream. The achievable thrust increases because the force depends on mass and acceleration (Δv).

To achieve the higher injection speed, it is optionally possible to increase the power of the turbopump, operate in expander mode, or lower the combustion temperature (i.e. more favorable system characteristic for cooling).

Alternatively, a second pressure stage/pump stage could also be installed in the cooling circuit. However, this is not currently preferred due to the resulting complexity and costs, especially for turbopumps. However, this can also be counteracted by power-reduced subsystems (turbopumps).

[Variant 4] Combustion with Maximized Temperature:

This variant concerns a maximized combustion temperature “superadiabatically”, i.e. possibly above the stoichiometric combustion temperature. This can be realized by non-uniform mixing of the fuel before it enters the catalyst [13] [17] or by using a heterogeneous catalyst with a larger surface area and feeding the heat of reaction back into the fresh gas mass flow [14].

Processes are particularly intense when the catalytic surface area is high due to porous structures. At a hot catalyst material, the reaction mixture is heated (preheated). After chemical reaction, part of the reaction heat is reflected, or transferred, to the catalyst material. In conjunction with the preheating, the usual adiabatic combustion temperatures can thus be exceeded. Part of the combustion energy is recirculated through the solid catalyst [14].

Variants 1 to 4 are technically implemented by the following mechanisms:
[a] limitation of the flow resistance
[b] catalytic high-temperature alloys
[c] surface treatment/chemical activation
[d] combination with homogeneous catalysts
[e] adaptation of combustion chamber geometry
[f] control of combustion kinetics (temperature, pressure, velocity]
[g] Increase of the reaction rate

[A] to Limit the Flow Resistance

A system must be used that does not overload the other components, such as the turbopumps. For example, catalyst beds with high flow resistance would lead to higher pressure losses. The task is solved by using heterogeneous catalysts with the lowest possible flow resistance (e.g. catalysts aligned in the direction of flow, mix plates, splash plates or concentric plates).

In addition, a coating (e.g., gold, platinum) can be applied internally to the engine to reduce and prevent recombination of the reactants and thermal conduction of energy.

[b] on High-Temperature Catalytic Alloys

In order to achieve the required high-temperature strength in the combustion chamber for heterogeneous catalysts, platinum/platinum metals or noble metals (e.g. palladium, gold) are used on the one hand and in combination with alloy metals with a high melting point. Suitable alloying metals are high-temperature metals (refractory metals) such as tungsten, vanadium or, in particular, molybdenum, which also have valuable paramagnetic properties. Therefore, these are particularly suitable as promoters. In order to improve the heat balance of the catalyst materials, reactive cooling is used on the heterogeneous catalysts, if necessary in combination with staged injection.

To reduce costs, precious metal-rich alloys are to be arranged on the surface only. The composite is produced, for example, by soldering, welding or melting onto the high-temperature material/catalyst core. This produces a polymetallic material. The combination of various metals, in particular platinum (melting point approx. 1,772° C.), rhodium (melting point approx. 1,966° C.), gold (melting point approx. 1,064° C.) with those of tungsten (melting point approx. 3,410° C.), rhenium (melting point approx. 3,180° C.), Osram (melting point approx. 3,045° C.), Iridium (melting point approx. 2,410° C.), Molybdenum (melting point approx. 2,617° C.), Vanadium (melting point approx. 1,890° C.) leads to an alloy with a higher thermal load. The thermal load can also be increased by reactive cooling of the catalyst elements by means of injection, or added fuel. As a result, the workpiece can be used as a catalyst in the combustion chamber for the conversion of hydrogen or methane with pure oxygen. For example, the catalyst can lower the maximum combustion temperature and drive the achievable kinetic efficiency of the rocket engine system to a higher level. This is associated with improved combustion, less deflagration, less dissipation into heat, less cooling requirements, and lighter/longer lasting engine systems. In addition, dissociated components are smaller, or more easily movable, and react more quickly with each other in the combustion chamber. This can counteract unwanted escape of reaction energy. A possible use of aerospikes is facilitated.

Platinum-tungsten: In order to achieve the highest possible catalytic reactivity and at the same time the greatest possible stability, a combination of platinum with tungsten is the ideal solution. Tungsten has the highest known melting point of all metals of 3,410° C. However, tungsten already tends to oxidize strongly with oxygen or react with hydrogen at temperatures above approx. 400° C. This is why it is important to combine tungsten with platinum. It should be noted that oxidized tungsten itself is cited as a catalyst and passivation occurs. Although thrust engines for vertical takeoff are designed to burn for a few minutes, an improvement in durability should be sought by alloying with platinum as a catalyst. Although platinum is highly reactive catalytically to oxygen and hydrogen, it is also extremely chemically resistant. Platinum also exhibits good forgeability and ductility and is mechanically promising. Tungsten generally tends to become brittle when alloyed with other metals.

A platinum tungsten alloy is used, for example, for long-term applications on spark plugs (automotive sector). The high chemical reactivity of tungsten at higher temperatures, especially with hydrogen and oxygen, must be taken into account. Tungsten and platinum are not completely soluble in each other in the solid state over the entire mixture scale, since different phases are formed in some cases due to different properties. Therefore, an alloy of 20% tungsten to 80% platinum (atomic proportions) is preferred and a melting temperature of about 2,000° C. is achieved. However, a higher proportion of tungsten can also be used if the service life is shorter or the required chemical resistance is reduced. By adding 25% platinum to 75% tungsten, the melting temperature can be increased to approx. 2,460 C. The combination of platinum and tungsten has further potential [4], e.g. by mixing in other components. Due to its favorable procurement, tungsten is a possible carrier material, with limited chemical and mechanical suitability (in alloys).

Platinum-rhenium: Catalysts with partly different alloys or coatings of platinum and rhenium are already in proven use for increasing the octane rating of unleaded gasoline (reforming). Rhenium is an excellent complement to platinum, since the melting point of rhenium is approx. 3,180° C., surpassed among metals only by tungsten, which has a melting point of approx. 3,410° C. At the same time, platinum and rhenium have a high octane rating. At the same time, platinum and rhenium have a high solubility with each other, which allows the alloying proportions to be varied. Another advantage of rhenium over tungsten is its higher chemical resistance to oxygen and hydrogen-especially at higher temperatures. Rhenium also counteracts certain catalyst aging processes (e.g. coking when combined with hydrocarbons). Therefore, rhenium is a promising promoter for long-term applications. It is balanced by weight ratio of platinum to rhenium. The proportion of platinum is maximized to achieve the highest possible catalytic reactivity at an increased melting temperature. Thus, an alloy of 55% platinum to 45% rhenium is favored. This results in a permissible melting temperature of over 2,400° C. according to the Solidus line. With an alternative further increase of the rare rhenium to approx. 90% and approx. 10% platinum addition, an increase in the melting temperature of the alloy to over 2,900° C. is possible. The higher working temperature improves the catalytic activity of the respective materials. Additions of elements of particular catalytic interest, such as silver, copper and palladium, have also proved successful with platinum-rhenium. Alternatively, ruthenium and molybdenum are also relevant. The melting points of silver (approx. 962° C.), copper (approx. 1,083° C.) and palladium (approx. 1,552° C.) are below those of refractory metals and are therefore only of interest for doping in the following.

Platinum-molybdenum: The combination of platinum and molybdenum is promising due to the high melting point of molybdenum (approx. 2,617° C.). Molybdenum can be procured comparatively cheaply at around €40/kg. The price level is roughly comparable to tungsten. In order to increase the melting point of the alloy as much as possible to about 2,000 C with the greatest possible increase in catalytic activity, a ratio of about 50% platinum to 50% molybdenum is favored. However, the melting point achievable with this alloy is significantly lower than the melting points of most other high-temperature alloys.

Molybdenum is also a promising carrier material for catalytic noble coating because of its relatively low price, mechanical properties and high chemical resistance. Thus, the strength, toughness and hardness of molybdenum are promising.

Iridium-Osmium: Iridium and osmium are platinum metals. The combination of iridium and osmium has very good catalytic properties for reactions with hydrogen. Iridosmium and Osmiridium are well known and proven alloys. Thermal stability is distinctly advantageous, since osmium offers a melting point above about 3,045° C. and iridium is also a refractory metal. With a preferred mixture of about 50% iridium to about 50% osmium, a melting temperature of over 2,600° C. is achievable. If the alloy content of osmium is increased to about 80%, even more than 2,800° C. melting temperature is achievable [5]. Iridium has a high price of approx. 3,660 €/ounce, or approx. 31 g each (as of January 2022) and is thus currently significantly more expensive than gold or even platinum. Osmium is the most expensive material in the analysis with over 1,670 €/g and a strong trend towards further price increases (as of January 2022).

Iridium-osmium-platinum: A ternary system of iridium, osmium and platinum is suitable for increasing catalytic activity. With a proportion of approx. 45% iridium, approx. 30% osmium, to approx. 25% platinum, a melting point of approx. 2,400° C. results [5].

Iridium-rhenium-rhodium: Iridium and rhodium are platinum metals. In this alloy system, a high melting point of the catalysts can be achieved simultaneously with a high proportion of the platinum metals. With an alloy of approx. 42% iridium, approx. 33% rhenium, approx. 25% rhodium, a melting point of approx. 2,700° C. can be achieved.

Platinum-rhodium: Rhodium has a high melting point of approx. 1,966° C. Platinum and rhodium are not completely soluble in each other. Alloys with the main components platinum and rhodium have a maximum melting point of less than 2,000° C. A major advantage of rhodium is its high catalytic activity, especially towards nitrogen oxides, which is relevant for air-breathing engines. An alloy of about 70% platinum and about 30% rhodium with a melting temperature above 1,800° C. is preferred. However, this alloy has the lowest melting point of all the alloys mentioned in the Treiber concept.

Material Selection

The possible application temperature increases the catalytic activity. A higher melting point favors and reduces premature melting of the surface of the catalyst, or premature removal of the catalytic coating by mechanical action. Alternatively, higher proportions of more solid materials (molybdenum) can be used for this purpose. The level of precious metals, especially platinum metals, increases the activity of the catalyst and its chemical resistance. Platinum will probably continue to be available in sufficient capacities at affordable prices in the future due to the downward trend in its use in diesel catalytic converters. After operating cycle, catalyst compounds in vehicles are increasingly recycled. Due to the high catalytic activity, a coating of a platinum-rhenium alloy on a molybdenum support/base body is described below as a representative example. Rhenium counteracts premature coking and increases the service life of the catalyst. Alternatively, the base body can also be made of tungsten or vanadium.

By combination with reactive cooling (continuous fuel transport) and with additional injection of homogeneous catalysts into the combustion chamber, additional cooling of the combustion chamber and the heterogeneous catalyst is possible. A disadvantage on the reaction rate and thus exit velocity at the nozzle cannot be derived.

The effect of the Treiber concept is significantly higher in air-breathing engine systems, since only short dwell times are available in the engine for the most comprehensive combustion/burnout possible. The objective of this patent specification is also to support the Heber concept (reference 10 2021 004 807.5) under the highly variable challenges of a targeted vertical takeoff. These include increasing inflow velocity/compression and, in contrast, decreasing density of the approaching air with at least an intermediate maximum air mass flow.

[c] Surface Treatment/Chemical Activation

Since the activity of catalysts depends on the surface of the catalysts, adaptation and structuring of the surface is advantageous. Heterogeneous catalysts can be chemically activated by mechanical or electromagnetic methods. Mechanical processes have the advantage of achieving effects with little effort (e.g. grinding, use of abrasives by means of different fractions of sand grains, rolling, etc.). Here, roughness can be selectively applied by reverse grinding for roughening, starting with finer and then further grinding with coarser abrasive material. If necessary, these are to be carried out from different grinding angles/or beam angles. Electromagnetic processes, such as pulsed laser radiation, ion radiation and electron radiation, allow further optimization or control and refinement of the surface structure. Interference techniques or appropriate masks can be used as aids [2].

Fiber contours are ideal for creating a particularly chemically active surface. At the same time, the flow near the surface can be made more turbulent. The largest possible specific surface achievable according to this principle is created by tiny fibers, which are attached transversely or longitudinally to the support/catalyst body. Pragmatically, chips or fibers from the mechanical processing of the blank or catalyst base body can also be drawn/used. To attach the fibers/abrasion, the catalyst body must be surface melted (e.g. by laser radiation, thermal pretreatment, etc.). When the cooler solid fibers come into contact with the partially melted/welded catalyst hulls, a bond is formed and, further on, a fur-like/fibrous surface. Alternatively, a catalytic sponge can be melted on, or used.

As a result of the treatment, the workpieces or base bodies have a higher specific surface (e.g. holes, grooves, fibers). As a result, selected thermally highly stressable materials (such as tungsten, molybdenum), chemically/catalytically charged, can be used in the combustion chamber. This mimics the diffuse surface of platinum.

[d] Combination with Homogeneous Catalysts

A major advantage with homogeneous catalysts is the effect over the wide spatial range of the transport/mass flow. Frequencies can be changed in the process. The effective range extends directly to the mass flow of the reaction products, such as reducing agent and oxidizer. In this way, the catalysts are targeted inside the combustion chamber. This means the greatest possible effect before the combustion process and along the combustion chamber is advantageous. If the injected homogeneous catalysts or metal particles oxidize, a positive effect on the specific impulse may result (ternary systems). Furthermore, homogeneous catalysts are already used for cleaning deposits in combustion chamber walls (e.g. US 2011/0154726 A1, or US 2009/0056207A1), but not yet specifically recatalyzing heterogeneous catalysts of chemical engine systems. Injection of the homogeneous catalysts is thus intended to counteract deposits on the heterogeneous catalysts and clean them. Stable conditions are created by a low-coking catalyst alloy (e.g. approx. platinum 55% and high proportion of rhenium of approx. 45%) and injected homogeneous catalysts. The further addition of homogeneous catalysts can also be advantageous for bringing the heterogeneous catalysts up to operating temperature and avoiding pressure/temperature fluctuations.

In addition, the homogeneous catalysts can be thermally excited in a targeted manner (e.g. by means of a microwave). In this way, the chemical activity can be increased. In addition, the initiation of ignition of the fuel and further regeneration of the heterogeneous catalysts is further improved. Also, increasing the load of homogeneous catalysts should further lower the combustion temperature and convert the chemical energy of the fuel into kinetic energy more directly. The advantage of activation by means of ionized excitation has also already been technically demonstrated for heterogeneous catalysts (e.g. patent specification DD 77961).

Homogeneous catalysts can be combined from fine particles of several platinum group metals and promoters of subgroups I, II, VIA, V, VI and VII. This is possible by fine distribution of small catalytic particles in the fuel (suspension). Preference is given to the use of small amounts of platinum, palladium, rhodium, ruthenium and other precious metals. These are to be added to the fuel/fuel components. However, rhodium and ruthenium are classified as toxic and should be considered separately. Some palladium and platinum compounds can be harmful, or toxic. In the following, however, a probably positive environmental and health balance is assumed due to the low concentration in the microgram range per kg of fuel. At the same time, emissions are eliminated (less fuel combustion) and there is no direct human exposure for this application.

Per kg of fuel, approx. 20 μg platinum, approx. 20 μg rhenium, approx. 20 μg molybdenum and approx. 20 μg vanadium, as well as approx. 20 μg palladium or alternatively rhodium are used. In total, this results in approx. 100 μg catalysts/kg fuel. The grain/particle size is less than 10 μm.

In addition, the combustion kinetics can be varied by stimulating the homogeneous catalysts by means of electromagnetic radiation or microwave radiation (Reference Number DE 10 2021 001 272.0 of the applicant with the same name). For this purpose, a microwave radiator can be installed behind an electrically non-conductive workpiece (e.g. high-temperature ceramic). The workpiece can be arranged at the combustion chamber. The homogeneous catalysts stimulated in this way are additionally kinetically and thermally excited. To supply the microwave with electrical energy, thermocouples or electrical generators can be used, for example. The latter could be installed or connected to the turbopump. In partial reference to the Treiber concept and the contactless electromagnetic ignition, a higher-level adapted process concept has also been applied for (Ref. DE 10 2021 004 141.0 of the applicant with the same name).

Alternatively, base homogeneous catalysts made of iron compounds, for example, are also possible. These include, for example, magnetite, hematite or ferrihydrite with mass fractions of a maximum of a few percent of the fuel. These allow an increase in quantitative freight rates at a favorable price. This is interesting as an alternative, for example, at the highest combustion chamber temperatures to compensate for the short half-life of catalytic activity compared with refractory metals. Also, the temporary melting of such catalysts of medium temperature stability can buffer the combustion temperature. Thus, thermal energy for the region after constriction in the system is temporarily transferred as phase change enthalpy into latent heat. In this way, the engine temperature can be limited. It is interesting to note that phase transitions cushion temperature peaks until a complete phase change occurs. This is particularly interesting for air-breathing propulsion systems with lower reaction temperatures than chemical rocket engine systems. Alternatively or additionally, it is possible to regulate in via evaporation at higher temperatures. A technical solution for this approach is an increased injection velocity of the iron compounds in order to penetrate as deeply as possible into the active combustion chamber. By design, this can be increased by injection downstream, e.g. at splash plates or separate injection nozzles (e.g. FIGS. 7a-7c, or FIGS. 8a-8b). Heterogeneous catalysts of iron compounds are also possible. Molybdenum or vanadium are also of interest, e.g. for wall flows along combustion chamber walls.

[e] Adaptation of the Combustion Chamber Geometry

For the energetic evaluation of an adaptation of the combustion chamber geometry, the general losses of a chemical rocket engine system according to [6] are broken down below:

1. radial velocity component at the nozzle exit.

2. spatial and temporal non-uniform velocity, so-called profile loss

3. friction losses

4. heat losses to the outside and fuel leakage losses

5. incomplete expansion pe>0

6. incomplete combustion and reactions (i.e. imbalance in the expansion flow)

In general, thermodynamically a higher exit velocity at the nozzle outlet is achieved at higher temperature. However, catalysts can additionally change the reaction conditions towards catalytic combustion. The reaction energy/enthalpy is converted in an accelerated reaction. Due to these adapted conditions and reaction mechanisms, a lower-loss conversion into kinetic energy is aimed for. This is to be achieved, for example, by changing the pressure gradient or impulse in the engine. By intensifying the reactions in a smaller space, it is also possible to reduce the possible different power losses across the reduced system areas/boundaries of the engine. The difference to the critical Mach number can thus be changed on the reaction side and, if necessary, minimized. A reduction of heat losses is especially advantageous for smaller and medium sized engines due to typically higher fractions [6]. Last but not least, an elimination of engine mass also represents additional potential for the payload.

The combustion, which is made more uniform and adapted by homogeneous and heterogeneous catalysts, can be expected to result in lower radial velocity components and heat losses. With reduced constriction, positive effects result. For this purpose, targeted concentration differences along the combustion chamber cross-section are also possible, for example. This may reduce internal friction losses in the flow of the combustion chamber.

Aerospikes could technically be realized more easily by lowering the combustion temperature. With aerospikes, kinematic jet losses can be reduced at variable ambient pressures due to the design (e.g. during vertical takeoffs).

By changing the temperature, pressure and reaction rate, it is thus possible to adapt and, if necessary, optimize the combustion chamber geometry. This results in promising energy potentials. According to [6], other geometries are possible in addition to cylindrical combustion chambers. These are, for example, tubular or conical combustion chambers. The constriction for energy conversion in a Laval nozzle is always associated with energetic efficiency losses. This results in

heat losses and fluidic disadvantages such as friction, turbulence, disadvantageous

multiple transverse accelerations (converging/diverging alternation) and profile losses, or partial backflows near the nozzle.

Conical or tubular combustion chambers can also be designed in an improved manner, as combustion rates are increased. For example, temperature-regulated combustion can take place near the engine walls with the appropriate catalytic load. Hereby, the thermomechanical loads are more uniform and more gentle for the lifetime of the engine.

[f] Control of Combustion Kinetics (Temperature, Pressure, Velocity).

Combustion kinetics affects the kinematic jet losses, or the effectively usable thrust fraction of the expended power (chemical energy supplied). In one example, the kinematic jet losses can amount to about 25% of the expended power in the chemical engine [6]. In contrast, the expendable payload fraction is only a few percent of the total launch mass of a rocket (low Earth orbit).

The complex combustion kinetics depend in particular on the geometry of the combustion chambers, the nozzle throat and the downstream nozzle. In addition, fluidic profile losses and detachment phenomena occur. These depend, for example, on the changing ambient pressure of a vertical start. In principle, the geometries of combustion chambers and nozzles are fixed and the pressure of the engine at the nozzle outlet is fixed. In the case of aerospikes and certain special shapes, the pressure at the nozzle outlet can adapt to the changing ambient pressure, or is released freely. Since the external pressure varies with altitude during vertical takeoffs, kinematic jet losses can result when conventional bell nozzles are used. These result from over-expansion (higher ambient pressure) or under-expansion (lower ambient pressure).

In the context of this invention, it is therefore proposed to influence the complex combustion kinetics by homogeneous catalysts and metallic components in a temporally or spatially variable manner, if necessary (ternary system). This is of particular interest for conventional bell nozzles. In bell nozzles, the injection of homogeneous catalysts and metallic components can therefore be specifically adapted to the varying external pressure. Variable concentrations or loads over the radius of the flow/flow cross-section are a further spatial option.

In the startup phase, maximum loads of homogeneous catalysts and metallic particles (ternary system) are injected into the fuel of the engine system at high ambient pressure. The homogeneous catalysts change the temperature and pressure in the engine system. And can lower the temperature and increase the pressure, if necessary. In addition, metallic particles can be injected to further increase the pressure in the engine system. At the same time, thrust is maximized by the ternary system, especially in the energetically demanding startup phase.

With increasing altitude and thus decreasing ambient pressure, the loads of homogeneous catalysts and metallic particles must be reduced or continuously adjusted. As a result, the temperature in the combustion chamber, for example, can increase and the pressure at the nozzle outlet can decrease. This can be applied continuously until the end of the engine system's service life. The aim is to match the pressure at the nozzle outlet to the ambient pressure in order to reduce kinematic jet losses as far as possible.

This design is based on the assumption that, with lower energy consumption, reduced fuel consumption in the engine system as a whole can nevertheless be energetically advantageous. In this way, kinematic jet losses can be minimized if necessary. The comments refer to bell nozzles. In the case of aerospikes, this may allow the size of the nozzle to be reduced or the weight to be reduced (e.g. through higher throughput).

Reference has already been made to a possible additional stimulation of the homogeneous catalysts by means of electromagnetic excitation (Ref. DE 10 2021 001 272.0) of the applicant of the same name). In partial reference to the Treiber concept and the contactless electromagnetic ignition, a superordinate adapted process concept has also been applied for (Ref. DE 10 2021 004 141.0 of the applicant of the same name).

This excitation by means of electromagnetic radiation is not only relevant with regard to temperature-related activity of the catalyst. Under certain circumstances, excitation can take place in a specific direction. Basically, several theories exist on the effect of catalysts according to the state of the art. The widely used radical theory describes the facilitated ionization by catalysts. In addition, there is also the theory of the photo-catalytic effect. According to this theory, certain catalysts emit electromagnetic radiation (UV radiation) and stimulate the reactants to react [9].

Advantageously, uniform conditions and distributions of catalysts and propellant are easier to realize in liquid systems than in solid systems. It is also possible to suspend the homogeneous catalysts in a “knocking agent”. Similar to combustion engines, alcohol or even water, for example, are known in this respect. These knocking agents can be used to counteract the pressure fluctuations during combustion. Further countermeasures are listed in [Variant 2]. One measure is the division of the combustion chamber.

Catalytic effects are also of interest outside regular operation. For example, catalytic converters are advantageous during startup, with reduced thrust, or in a combustion shutdown phase to stabilize and adjust combustion (including the turbopump).

[g] Increasing the Reaction Rate

According to [16], research has shown that temperatures do not significantly affect the reaction rate of ions. However, the concentrations of reactants that produce ions are increased at higher temperatures. Catalysts can generally generate additional radicals (radical theory), or decrease the required activation energy.

### BRIEF DESCRIPTION OF THE DRAWING FIG.S

FIG. 1a: Process diagram: combined combustion

FIG. 1b: Process diagram: staged combustion

FIG. 1c: Process scheme: mass flow enhanced combustion

FIG. 1d: Process scheme: superadiabatic combustion

FIG. 1e: Process scheme: single-stage catalytic flooding

FIG. 1f: Process scheme: multistage catalytic flooding

FIG. 2a: Homogeneous catalysts: suspension

FIG. 2b: Homogeneous catalysts: Fibers

FIG. 3a: Homogeneous catalysts: injection, side stream

FIG. 3b: Homogeneous catalysts: injection, main stream

FIG. 3c: Homogeneous catalysts: injection, multi-way injection

FIG. 3d: Homogeneous catalysts: variable injection with metal particles

FIG. 4a: Heterogeneous catalysts: profiled combustion chamber walls

FIG. 4b: Heterogeneous catalysts: Axial plates

FIG. 4c: Heterogeneous catalysts: Honeycomb structure

FIG. 4d: Heterogeneous catalysts: elongated structure

FIG. 4e: Heterogeneous catalysts: concentric

FIG. 5: Heterogeneous catalysts: Structure/surface

FIG. 6: Turbopump

FIG. 7a: Engine system (rocket): stretched arrangement, oxidizer

FIG. 7b: Engine system (rocket): stretched arrangement, splash plate

FIG. 7c: Engine system (rocket): stretched arrangement

FIG. 7d: Engine system (rocket): stretched arrangement, mixing plate

FIG. 8a: Engine system (rocket): honeycomb structure, multistage

FIG. 8b: Thruster system (rocket): concentric arrangement, multistage

FIG. 9a: Engine system (rocket): honeycomb structure, single stage

FIG. 9b: Engine system (rocket): concentric arrangement, single stage

FIG. 10: Engine system (aerospike): reduced constriction

FIG. 11: Engine system (scramjet): partial coating

FIG. 12: Engine system (scramjet): complete coating

FIG. 13: Engine system (Ramjet): partial coating

FIG. 14: Engine system (ramjet): full coating

FIG. 15: Engine system (pulse jet engine)

The above designs are examples. Further variants are described in the patent specification and in the claims.

In general, the Treiber concept includes heterogeneous catalysts (1) placed as close as possible to the reaction zone of the combustion chamber (3). In rocket engine systems, or turbopumps, additions are made by means of homogeneous catalysts (2). In the following, the propellant (4) consists in simplified form of a reducing agent (5) which is reacted with an oxidizer (6). In addition, single-substance/multi-substance systems can also be used as a substitute, which are also included and described here as a substitute.

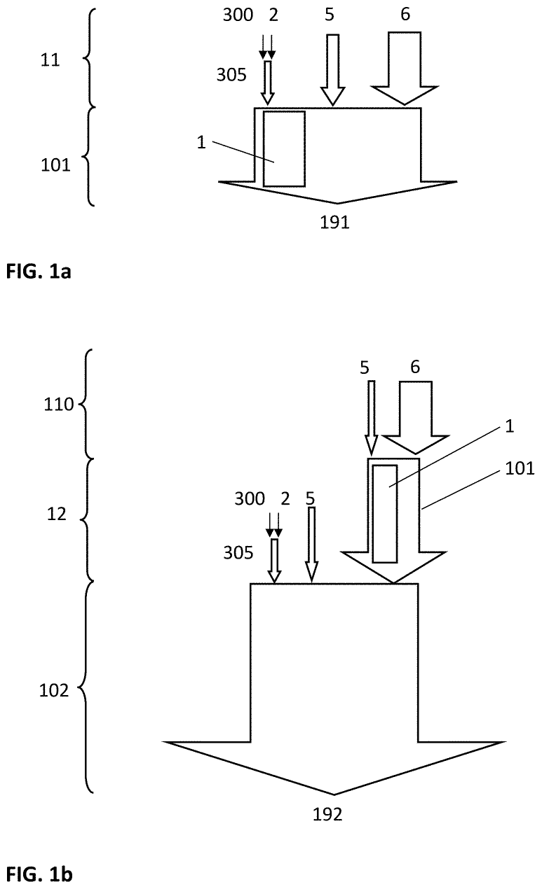

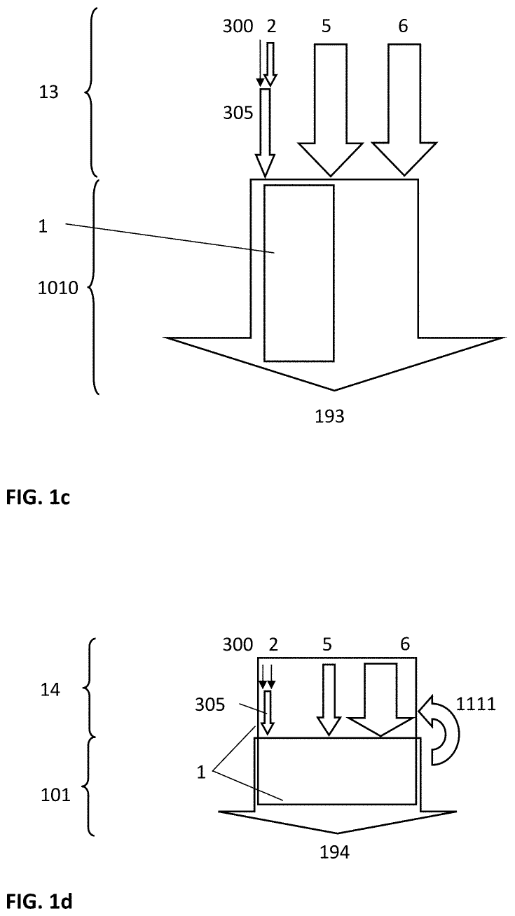

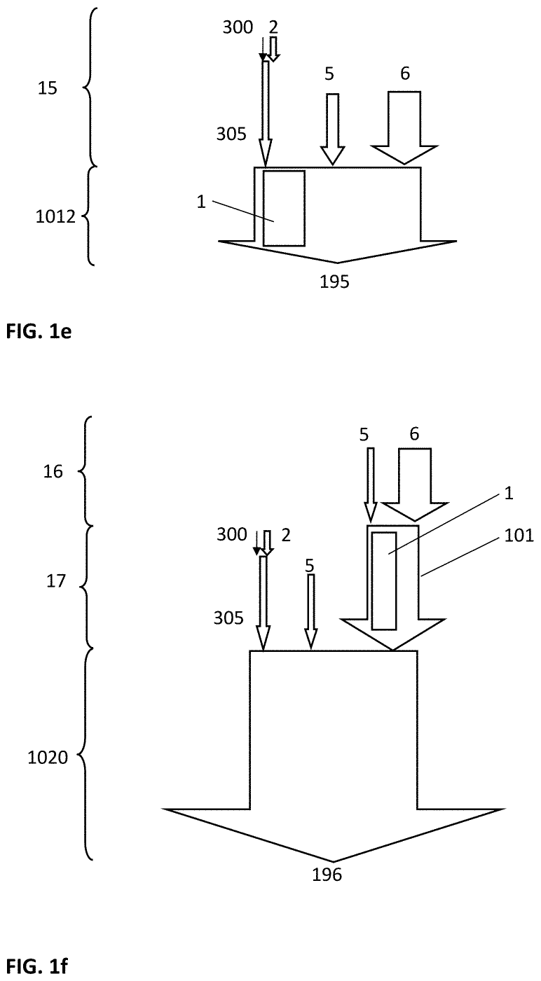

The embodiments of FIGS. 1-4 describe the basic structure of the insert in the combustion chamber of a rocket engine system, or alternatively in air-breathing engine systems (e.g., ramjets, scramjets, pulse jet engines).

FIG. 1a: Process Diagram: Combined Combustion

This FIG. shows a possible process scheme for a possible variant of the Treiber concept.

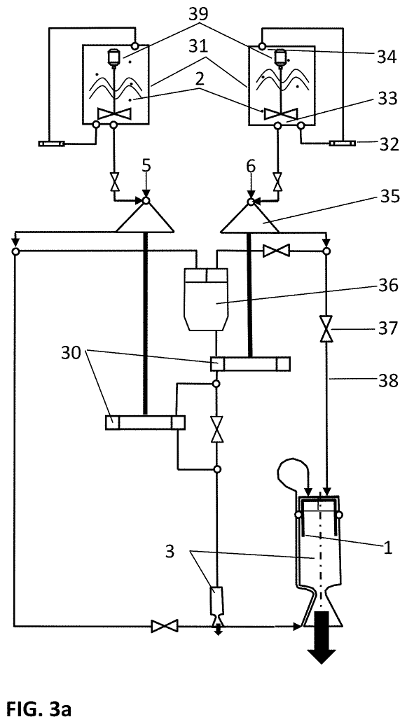

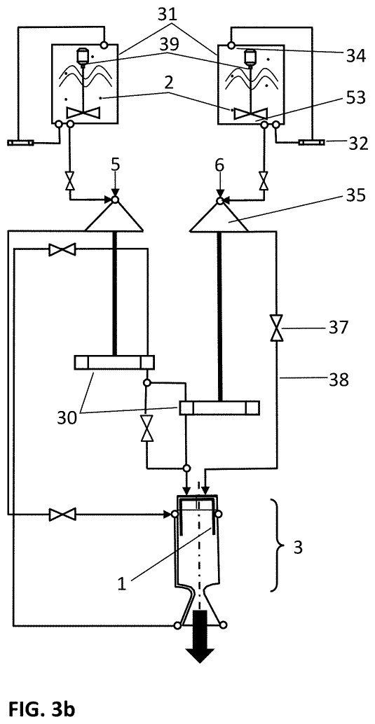

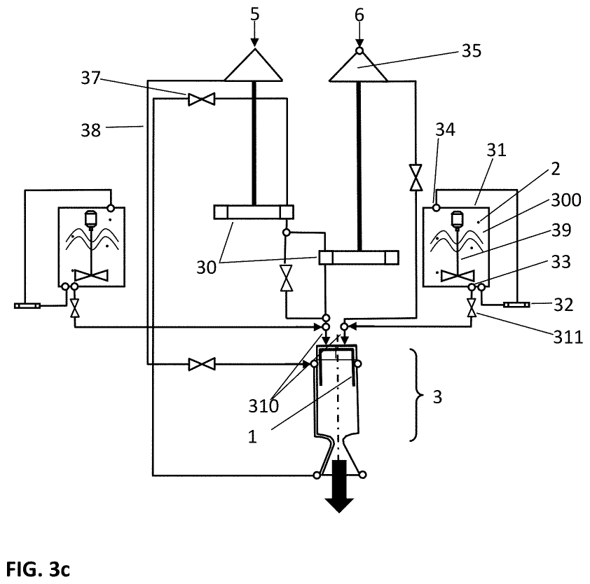

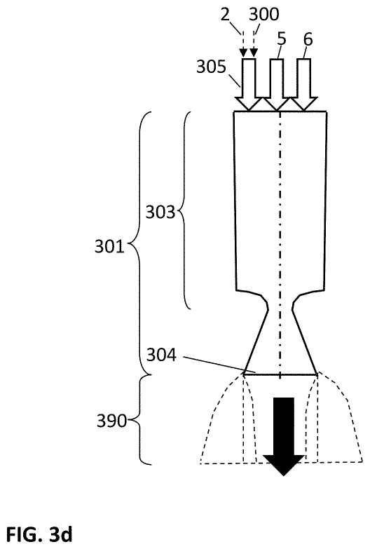

Single-stage injection (11) introduces the reactants into the combustion (101). The single-stage injection (11) supplies chemical energy for the combustion process (101) The reducing agent/fuel (5) consists of e.g. H₂, RP1 or CH₄. As oxidizer (6) e.g. O₂ or also air/air oxygen is supplied. Essential in the Treiber concept is the introduction of catalysts such as fine platinum particles as homogeneous catalysts (2) dissolved in liquid solvent (300) such as alcohol. The resulting suspension (305) can be injected separately. Alternatively, earlier mixing into the fuel mass flow, e.g. the fuel (5) before injection, is also possible (e.g. FIGS. 3a to 3c).

After injection in the combustion chamber, combustion (101) takes place with the assistance of heterogeneous catalysts (1) such as combustion chamber walls coated with an alloy of platinum and rhenium. These coatings interact with the reactants and combustion chamber conditions. For example, platinum or alternatively gold has a high capacity for heat reflection. Also, the heterogeneous catalysts (1) can be refreshed by the homogeneous catalysts (2).

After combustion (101), only the heterogeneous catalysts (1) remain. The remaining reactants are consumed in the combustion process (101). The reaction products escape via the mass flow (191) formed. The mass flow (191) formed is used to partially convert energy into usable form, such as thrust. Further energy can be converted, for example, upstream or in parallel in the generator of a fuel pump/turbopump in an analogous manner.

The suspension (305) changes the reaction conditions of the combustion (101), such as the combustion pressure, the combustion temperature or the reaction time of the combustion (101). This can, for example, reduce energetic losses and increase the payload fraction for launches into low Earth orbit. This is possible, for example, by increasing the mass flow rate (191), changing the geometries at constrictions (Laval nozzle), or increasing burnout of reactants in air-breathing thrusters. Alternatively, further accelerated reactions under supersonic conditions are also possible.

As an alternative to homogeneous catalysts (2), metallic additives such as iron compounds with their own calorific value can also be added to the process in order to adjust or trigger the process conditions.

FIG. 1b: Process Scheme with Staged Combustion

Compared with FIG. 1a, a process scheme with multi-stage combustion (101+102) is shown.

Multi-stage combustion (101+102) can be used, for example, for air-breathing propulsion systems to increase burnout, or in rocket engine systems to further modify the process conditions, or to reduce the consumption of homogeneous catalysts (2). Further modified process conditions are also advantageous, for example, for subsequent energetically optimized supersonic combustion with short reaction times.

For the first injection (110), atmospheric oxygen or oxidizer (6) and lean fuel (5) are introduced into the combustion chamber. Alternatively, fuel (5) can also be introduced completely and ignited only partially. The combustion (101) of the first stage takes place at a heterogeneous catalyst (1). Thus, the combustion (101) of the first stage is lean, i.e. fuel-poor or oxygen-rich. Alternatively, fuel-rich combustion could also take place under oxygen deficiency.

A second combustion (102) takes place by downstream injection (12) of the second stage. For this purpose, further reactants are introduced, for example, at projecting nozzles, spray plates or mix plates (5+305). Alternatively, nozzles can also be installed and used on the geometries of heterogeneous catalysts (1). In this embodiment, these additional reaction partners are further fuel (5) and the suspension (305). The suspension (305) comprises homogeneous catalysts (2) in a solution (300). The solution (300) may consist of alcohol, for example.

The result is a mass flow (192) with changed pressure and temperature, or velocity.

FIG. 1c: Process Diagram: Mass Flow-Enhanced Combustion

In this FIG., the injected mass flows (13) are increased compared with FIG. 1a. To accelerate combustion (1010), higher mass flows of homogeneous catalysts (2) or homogeneous catalysts (2) with higher activity can be injected.

The increased injection (13) can be achieved, for example, via additional or more powerful turbopumps. In compensation, engines or other combustion systems (1010) can be dispensed with if necessary. This results in a more extensive mass flow (193).

FIG. 1d: Process Diagram: Superadiabatic Combustion

In this FIG., compared to FIG. 1a, the heterogeneous catalysts (1) have a strong thermal effect on the injection (14) of suspension (305), fuel (5) and oxygen (6).

In this FIG., combustion occurs at temperatures above those of stoichiometric conditions. These conditions exceed adiabatic conditions and are referred to as “superadiabatic”. This is made possible, for example, by appropriate heat conduction (1111) from the heterogeneous catalysts (1). It is assumed that the heterogeneous catalysts (1) have a correspondingly high melting point in combination with high thermal conductivity.

During combustion (101), heat energy is transferred, e.g. radiated, from the gas phase to the solid phase of the heterogeneous catalysts (1). Due to heat conduction in the heterogeneous catalysts (1), the fresh mass flow of the injection (14) is sufficiently heated/preheated accordingly. In addition, heating takes place in the combustion chamber itself. The heated injection (14) reacts in the combustion chamber and on the heterogeneous catalysts (1). As a result of the reaction enthalpy released, further heating takes place above the otherwise normal adiabatic combustion temperature. If the temperature of the gas phase finally exceeds the temperature of the solid body or the heterogeneous catalysts (1), the resulting heat flow is reversed in the direction of the heterogeneous catalysts (1).

A mass flow (194) from superadiabatic combustion is produced. The target can be e.g. the reduction of homogeneous catalysts (2).

FIG. 1e: Process Scheme: Single-Stage Catalytic Flooding

In this embodiment, compared to FIG. 1a, a process scheme is shown which is designed for high concentrations of homogeneous catalysts (2) during injection (15).

Low-cost iron-containing compounds such as hematite (Fe2O3), ferrihydrite, or other compounds such as TiO2 can be considered as possible homogeneous catalysts (2). For example, concentrations of about 1/20,000 up to about 2% or more can be economically introduced in the injected fuel mass flow (15). The arrow width of the homogeneous catalysts (2) is increased and the arrow length of the suspension (305) is increased.

Due to the relatively low melting temperatures of these compounds, e.g. at Fe₂O₃ approx. 1,539° C. or approx. 1,800 K, additional technological measures are advantageous for use in the Treiber concept. This delays premature melting of the homogeneous catalysts (2) in the combustion chamber.

For example, the injection speed of the homogeneous catalysts (2) can be increased. Additional distribution can be achieved by friction at different injection speeds and conditions of fluids. Also, the temperature of the solution (300) during injection (15) can be kept low to thermally dampen. Thus, the aim is to widen the catalytic reaction range. This is advantageous for high reaction rates.

To dampen pressure fluctuations during combustion (1012), measures of [Variant 2] can be used if necessary, such as:
Addition of “anti-knock agents” e.g. alcohol (as solution (300) for homogeneous catalysts (2)), or water;
Division of the combustion chamber into smaller sections/sections e.g. with intermediate areas or slightly diverging flow directions;
Combustion (1012) reduced near the wall (e.g. fuel-rich);
reduction of the respective ignition volume e.g. by larger number of nozzles;
maximum uniformity of the mixture in the combustion chamber;

use of different homogeneous catalysts (2).

The aim is to achieve the greatest possible regulation of combustion rate, combustion temperature and combustion pressure in the combustion chamber. The resulting mass flow (195) is adjusted.

In this FIG. the process scheme is characterized by multi-stage combustion (101+102) compared to embodiment FIG. 1e. This embodiment variant has a second injection (17) and a second combustion (1020). Compared to the embodiment variant FIG. 1e, the homogeneous catalysts (2) are introduced via downstream injection nozzles. The homogeneous catalysts (2) are analogously contained in a solution (300) to form a suspension (305). This enables additional penetration depth of the homogeneous catalysts (2) by design or geometry.

FIG. 1f: Process Scheme: Multistage Catalytic Flooding

In this FIG., the process scheme is characterized by multistage combustion (101+102) compared with the embodiment in FIG. 1e. This has a second injection (17) and second combustion (1020). In contrast to the embodiment variant FIG. 1e, the homogeneous catalysts (2) are introduced via downstream injection nozzles. The homogeneous catalysts (2) are contained analogously in a solution (300) to a suspension (305). This enables additional penetration depth of the homogeneous catalysts (2) by design or geometry.

Compared to embodiment 1 b, the homogeneous catalysts (2) in this FIG. if are injected at higher injection rates and concentrations. This is illustrated with a larger arrow width of the homogeneous catalysts (2) and a larger arrow length of the suspension (305) in the process schematic.

The mass flow (196) results from strongly adjusted conditions in the combustion chamber, such as pressure, temperature and velocity.

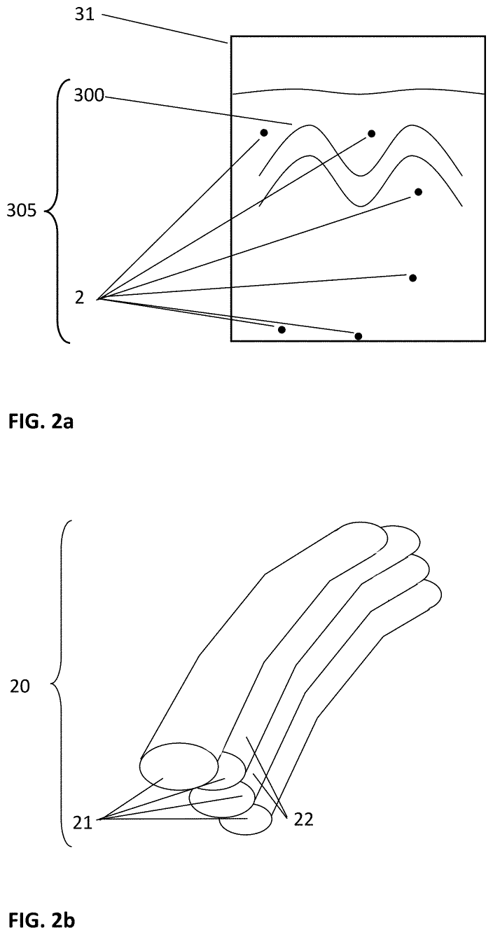

FIG. 2a: Homogeneous Catalysts: Suspension

In this embodiment, a suspension (305) of solvent (300) and homogeneous catalysts (2) is shown. The suspension (305) is located in a tank or reservoir (31).

The homogeneous catalysts (2) can consist of one metal (e.g. platinum); alloy or composite of several different metals (e.g. rhenium, gold, molybdenum). For the largest possible surface area, the particles of the homogeneous catalysts (2) have a diameter of only a few micrometers.

Alcohol has positive properties for combustion. Alcohol (ethanol) has a low melting point, keeps flow paths free of ice, is easily soluble and has its own calorific value. Alcohol can be mixed very well with water to further adjust the properties. Alcohol (ethanol) is also a good medium for metals. Last but not least, alcohol can be used in an environmentally friendly way. Also, with alcohol, the possibility of liquid storage at ambient temperature facilitates the use of pumps, mixers, pipes and the like. Alcohol is proven as an anti-knock agent in combustion engines. Alcohol (ethanol) is used selectively in numerous combustion processes, e.g. in highly concentrated form in methylated spirits or as a fuel additive. Depending on how it is injected into the mass flow, alcohol can also provide an additional period of time until ignition due to the ignition delay. When injected into the combustion chamber, this period can improve the uniformity of the components, including the homogeneous catalysts (2), and protect the engine system.

Alternatively, the homogeneous catalysts (2) can also be introduced via other matrix systems such as waxes, gels or thick materials. Although waxes or thick matter can fix homogeneous catalysts (2) better, they are more challenging in terms of uniform incorporation into the mass flow and pumpability. Surface films in the combustion chamber may be suitable for this purpose. One possible wax is kerosene wax, for example, which can be liquefied by heating near the combustion chamber. The particles of homogeneous catalysts (2) contained can be introduced in a uniform manner.

In contrast, the uniform introduction of the wax, or the suspension formed, is more complex.

In this embodiment, the homogeneous catalysts (2) are shown in a particulate fibrous structure (20). Fibers of different catalysts (21) are to be thermally bonded or sintered. Metal fibers approx. 0.5-1 μm thick, e.g. of platinum, aluminum, rhenium, molybdenum, are joined to a maximum length of approx. 100 μm. Alternatively, palladium and vanadium, for example, can also be used. The fibers (21) can partially melt or react in a candle-like manner and ensure simultaneous entry of the homogeneous catalysts (2) into the firing process and thus sustained activity. The fiber-like structure creates additional turbulence and thus the fibers (21) are distributed as far as possible into the combustion chamber. This is a particularly effective way of counteracting fouling on possible heterogeneous catalysts (1).

FIG. 2b: Homogeneous Catalysts: Fibers

In this embodiment, the homogeneous catalysts (2) are shown in a particulate fibrous structure (20). Fibers of different catalysts (21) are to be thermally bonded or sintered. Metal fibers approx. 0.5-1 μm thick, e.g. of platinum, aluminum, rhenium, molybdenum, are joined to a maximum length of approx. 100 μm. Alternatively, palladium and vanadium, for example, can also be used. The fibers (21) can partially melt or react in a candle-like manner and ensure simultaneous entry of the homogeneous catalysts (2) into the firing process and thus sustained activity. The fiber-like structure creates additional turbulence and thus the fibers (21) are distributed as far as possible into the combustion chamber. This is a particularly effective way of counteracting fouling on possible heterogeneous catalysts (1).

To further increase the catalytic activity, fibers (21) with different properties (22) are connected to each other. Based on different paramagnetic properties, different partial charges or voltages are targeted during electromagnetic excitation or activity. Thus, according to radical theory, the activity should be increased. Alternatively, these fibers (21) with different properties (22) can also be optimized with regard to their photo-catalytic properties.

Alternatively, simple fibers (21) coated or sintered with particles of other homogeneous catalysts are also possible.

FIG. 3a: Homogeneous Catalysts: Injection, Side Stream

In this embodiment, a scheme with homogeneous catalysts (2) is shown.

The average grain size of the homogeneous catalysts (2) is a maximum of 10 μm and the largest grain a maximum of 20 μm. For hydrocarbons (e.g. CH₄), on the other hand, approx. 20 μg platinum, approx. 20 μg rhenium, approx. 20 μg molybdenum and approx. 20 μg vanadium, as well as approx. 20 μg palladium are used per kg of fuel. In total, this results in approx. 100 μg catalyst/kg fuel.

Storage tanks (31) are arranged upstream of the generators (30) of the turbopumps (35), each with dissolved homogeneous catalysts (2) in reducing agent (5) or oxidizer (6). Valves (37) and lines (38) are also arranged. In the bypass principle, fuel is sucked in/pressurized from the reservoirs (31) both for the generators (30) of the turbopumps (35) and for the combustion chambers (3) of the engine systems. In the bypass principle, a mixer or mixing chamber (36) is also arranged upstream of the generators (30). For equalization, the solutions of homogeneous catalysts (2) and in each case a reducing agent (5) or oxidizing agent (6) are pumped in a circuit (32) and regularly equalized, e.g. supplemented by means of a mixer/agitator (39). In the storage tanks (31), the intake (33) is located at the bottom and the inlet at the top (34). The early feeding of the homogeneous catalysts (2) generally allows additional dissociation of the reducing agent (5) and oxidizing agent (6). In addition to the action of the homogeneous catalysts (2) in the combustion chamber (3), they also act in advance in the reducing (5) and oxidizing (6) agents supplied.

Heterogeneous catalysts (1) are installed in the combustion chamber (3). The injected homogeneous catalysts (2) counteract the coking or fouling on the heterogeneous catalysts (1) and flush them free again.

FIG. 3b: Homogeneous Catalysts: Injection, Main Stream

Compared to FIG. 3a, the mixing chamber is omitted.

In the main flow principle, the homogeneous catalysts (2) are drawn in analogously from the storage tanks (31) for supplying the generators (30) of the turbopumps (35).

FIG. 3c: Homogeneous catalysts: injection, multi-way injection In contrast to FIG. 3b, in this embodiment mixing into the mass flow takes place outside the turbopumps (30), or generators (35). Valves (37) are used to regulate the mass flow of fuel (5) and oxidizer (6) independently of the dissolved homogeneous catalysts (2). The homogeneous catalysts (2) are suspended in separate storage tanks in a solution (300), e.g. alcohol.

Metering takes place via valves (311) upstream of the multi-way nozzles (310). The multi-way nozzles (310) are used for injection in the combustion chamber (3). The homogeneous catalysts (2) and reducing agent (5) or oxidizer (6) are fed via a multiport configuration of the multiport nozzles (310). This reduces the additional work in the piping system (38) and fluidic losses. In addition, segregation, or enrichment in the line system (38) is avoided. The homogeneous catalyst (2) is admitted to one channel at each of the multi-way nozzles (310). For this purpose, storage tanks (31) of the homogeneous catalysts (2) are dissolved in reducing agent (5) and oxidizing agent (6). As a result of overpressure in the storage tanks (31), liquefaction of the solutions may take place. This facilitates the operation of the mixers (39) and pumps (32). Through respective inlets (34) and outlets (33) in the tanks, the suspensions can be pumped (32) and equalized in the circuit.

The additional homogeneous catalysts (2) to be injected counteract coking or fouling on the heterogeneous catalysts (1). Fouling is removed again by the homogeneous catalysts (2). In addition, oxidation of the surface of the combustion chamber (3) and thermal stress are reduced. In addition, uneven ignition delay in the combustion chamber (3) is reduced and pressure fluctuations are reduced in favor of more uniform combustion. The service life of the combustion chamber (3) and operational reliability are increased.

An advantage of this design variant is improved uniformity and protection against disturbances in one tank (31). The reason is the double and independent feeding by means of homogeneous catalysts (2).

FIG. 3d: Homogeneous Catalysts: Variable Injection with Metal Particles.

This embodiment represents another engine system with variable injection.

In the start-up phase, maximum loads of homogeneous catalysts (2) or metallic particles in a solution (300) are injected together with the reducing agent (5) or the oxidizer (6) at high external pressure. Homogeneous catalysts (2) and solution (300) form a suspension. The engine system (301) receives a variable injection of loads of homogeneous catalysts (2) with solution (300) or suspension (305). The suspension (305) of solution (300) and homogeneous catalysts (2) changes reaction rate, temperature and pressure in the combustion chamber (303). The temperature can be lowered and the pressure increased, if necessary. Both the pressure in the engine (301) and at the nozzle outlet (304) can be increased, if necessary, without raising the temperature of the combustion chamber (303) too much. At the same time, thrust is maximized by the ternary system during the startup phase. The expansion of the mass flow (390) at the nozzle outlet (304) is thus specifically changed.

With increasing altitude and thus decreasing external pressure, the loads of homogeneous catalysts (2) or metallic particles with the solution (300) must be reduced or continuously adjusted. Depending on the load, this can be done continuously until the end of the engine system (301). The aim is to equalize the pressure at the nozzle outlet to the ambient pressure in order to reduce or avoid kinematic jet losses as far as possible. This is relevant, for example, during a vertical launch into low earth orbit.

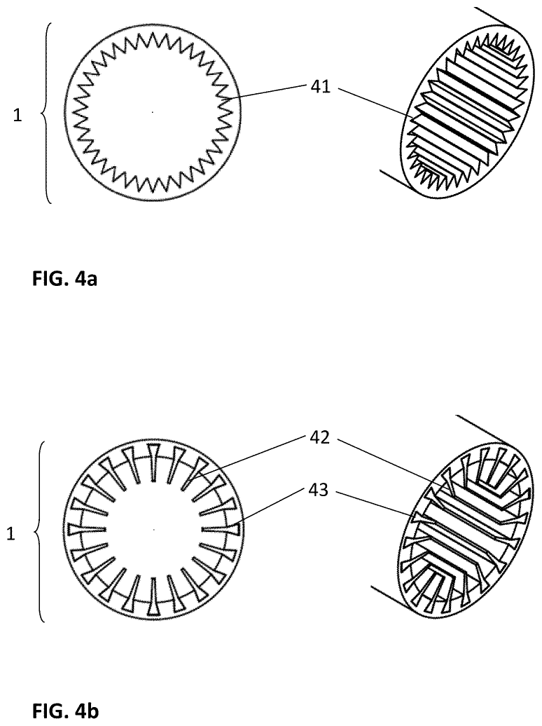

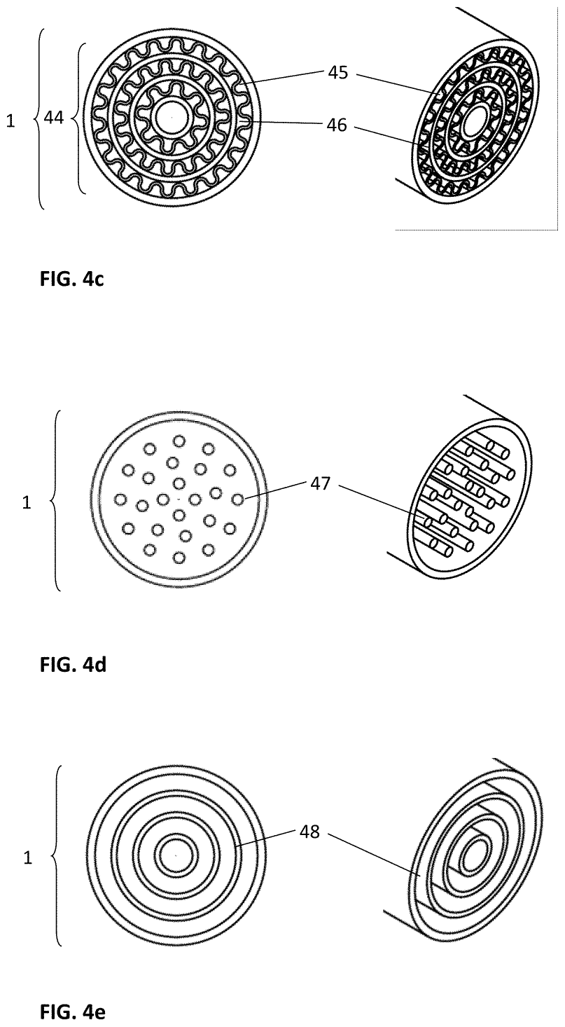

FIG. 4a: Heterogeneous Catalysts: Profiled Combustion Chamber Walls

In this embodiment, a basic shape of heterogeneous catalysts (1) is shown as profiled combustion chamber walls. In addition to the cross-section, a spatial projection is provided. As an alternative to the concentric cross-section, planar cross-sections with this profile shape are also possible.

These cross sections have pointed notches (41). The pointed notches (41) reduce the cross section through which the flow can pass near the wall. Edge flows can be specifically adapted. Heat reflection is also altered by inclined multi-surfaces. Gold and platinum have very good heat reflection properties above a certain layer thickness.

Another advantage of this basic shape is that the possible area for coating with heterogeneous catalysts (1) is increased. In addition, the profile can be adapted along the longitudinal axis, e.g. the notches downstream can be reduced.

FIG. 4b: Heterogeneous Catalysts: Axial Plates

Compared with FIG. 4a, this embodiment shows separate plates (42) with enlarged side surfaces. This further basic form of heterogeneous catalysts offers additional advantages.

The separate plates (42) embed themselves in holders (43) and can therefore be manufactured separately in a simplified manner. This opens up additional possibilities for production and combination.

Alternatively, the separate plates (42) can also be used for sectioning in the combustion chamber. In this way, spatial separation of the respective injection or combustion can be implemented, e.g. to avoid or reduce pressure peaks. In the engine systems of the Saturn V rocket, for example, separator plates were installed on the head plates/injector plates.

Alternatively, they can be redesigned or supplemented as splash plates. For this purpose, the ends of the separate plates (42) must be supplemented, e.g. with a round shape.

FIG. 4c: Heterogeneous Catalysts: Honeycomb Structure

In this embodiment of heterogeneous catalysts (1), honeycomb structures (44) are shown assembled to further increase the specific surface area. The honeycomb structures (44) consist of corrugated sheets (45) and separating ring sheets (46). This basic form is technologically known.

Alternatively, other divisions including a closed center are possible. In addition, the design as splash plates is possible. The splash plates can be used, for example, on the round ring plates (46).

FIG. 4d: Heterogeneous Catalysts: Elongated Stretched

In this embodiment, another possible basic shape of heterogeneous catalysts (1) is captured. With a round cross-section, elongated catalysts (47) are formed. The free cross-section is thus traversed as little as possible and as uniformly as possible.

The elongated catalytic converters (47) can also be used, for example, to arrange igniters or injectors. Another technological possibility is the installation of rod antennas for electromagnetic transmitters (e.g. microwaves).

Alternatively, the stretched catalytic converters (47) can also be tapered or curved at the end face.

FIG. 4e: Heterogeneous Catalysts: Concentric

In this variant, the familiar shape of heterogeneous catalysts (1) is made from concentric ring plates (48). Alternatively, these can also be formed into splash plates. A free core can be flowed through in the center.

Concentric ring plates (48) are particularly advantageous from a fluidic point of view for round cross sections. There are also similarities to the geometries of annular combustion chambers. Annular combustion chambers are generally considered to provide good combustion chamber conditions, especially for subsonic combustion.

Alternatively, other subdivisions or combinations of the design variants FIG. 4a to FIG. 4e are possible. Other variants are also possible in the longitudinal axis with a smooth end, round shape/circular shape (splash plate), or uniform variation of the individual profiles. In this way, an increasing free cross-section can be formed.

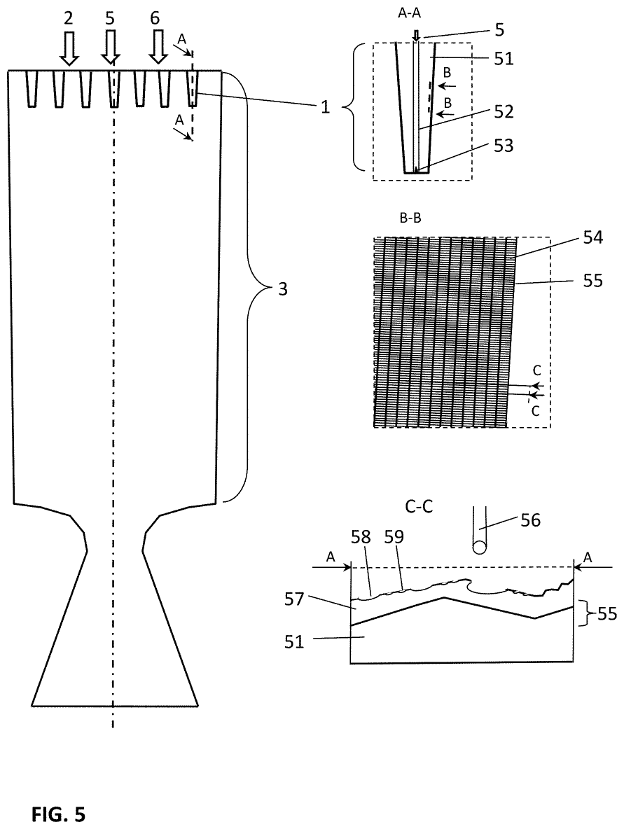

FIG. 5: Heterogeneous Catalysts: Structure/Surface

This design variant represents a further engine system.

Heterogeneous catalysts (1) are arranged in the combustion chamber (3). The heterogeneous catalysts (1) consist of a base body or core (51) made of a temperature-resistant alloy or material, preferably molybdenum. In this embodiment, a base body (51) made of molybdenum is shown. Alternatively, the base body (51) can be formed from tungsten or, for example, vanadium. In this base body (51), lines (52) are recessed or drilled in for reactive cooling, e.g. by means of reducing agents (5). Alternatively, cooling can also be achieved by means of the oxidizer (6). The reducing agent (5) can be injected into the combustion chamber (3) from these lines (52) via connected openings/nozzles (53).

The core (51) is roughened mechanically on the outside for further structuring and bonding. This can be done, for example, by precision grinding using diamond abrasives. A relief is applied starting with medium grinding (54) (e.g. 180 grit/mesh) followed by rough grinding (55) (e.g. 80 grit/mesh). Grinding residues on the surface must be removed (e.g. by oil-free blowing, tapping). For greater effectiveness of the grinding pattern, the medium grind (54) is imprinted perpendicular to the coarse grind (55). In addition, structuring can also be carried out by other mechanical methods (e.g. brushing or sandblasting) or further refined structuring can be carried out by electromagnetic methods (e.g. pulsed laser (56)).

The structuring increases the basic catalytic efficiency of the heterogeneous catalyst (1). It is also intended to increase the bond to the base body and the service life. This is also intended to constructively counteract a possible temperature gradient due to improved heat conduction and harmful relative deformations. In addition, the thermal conductivity in the connection can be adapted by increasing the contact area. Thermal destruction or sintering of the catalytic coating is thus counteracted. In principle, an intermediate layer/intermediate solder can also be added for this purpose, which has good thermal conductivity and is mechanically flexible (e.g. gold alloys, rhenium).

A layer (57) is applied to the base body (51). The layer (57) consists of a platinum-rhenium alloy (55% platinum and 45% rhenium), which is additionally doped with further platinum group metals, or with metals. For example, rhodium, ruthenium, palladium, silver, copper and molybdenum can be added in traces. The layer (57) can be applied, for example, by sintering on fine particles or melting on liquid phase. In the following, the term coating (57) is used for simplification purposes. The thickness of the applied coating (57) is preferably only about 100 μm in the submillimeter range. Depending on the further surface treatment selected, the thickness can also vary. A structure of craters (58) and grooves (59) is imprinted on the highly catalytic coating (57) by a pulsable laser (56). These craters (58) can comprise a length of about 1-10 μm and the grooves (59) a length of about 100 μm. The grooves (59) are imprinted in rows with a width of about 10 μm and spacing of about 10 μm from each other. The result is a structure which has a high specific surface area. The surface is thus additionally catalytically activated.

Alternatively, further layers can be applied, e.g. as sacrificial/wear layers, to create additional structures and increase the operating time. Thus, a further deepening of the structures is possible.

It should be noted that deposits of unburned components, residues, impurities and oxidic layers (fouling) inevitably form in the combustion chamber (3). This is counteracted not only by the alloying of the catalytic layer (57) with the high rhenium content of approx. 45% but also by the additional injection of homogeneous catalysts (2). Coking or fouling on the heterogeneous catalysts (1) is reduced/stopped.

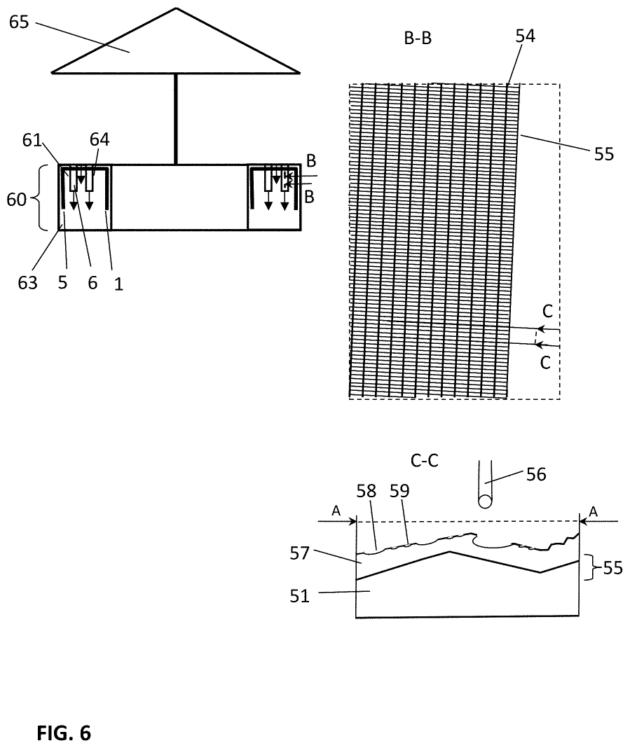

FIG. 6: Turbopump

This embodiment shows a turbopump (65) including a catalytically assisted generator (60) in schematic form.

In the generator (60) of the turbopump (65), heterogeneous catalysts (1) are applied to possible burners (61) or in the combustion chamber (63). The use of catalytic internals is also possible (basic shapes FIGS. 4a to 4e).

The reducing agent (5) and the oxidizer (6) are introduced via the injection (61). The output of the turbopump (60) is increased by converting chemical energy into kinetic energy more directly or with lower losses, and the heat generation is adjusted. Reduced temperature lowers the cooling effort and maximizes the strength of the materials. This allows a higher mechanical load, thus possible higher performance and service life of the turbopump (65), or generator (60).

At the burner (61) and the combustion chamber (63), the base bodies (64) of the heterogeneous catalysts (1) are mechanically roughened, e.g. medium (54) and coarse (55). For this purpose, abrasive paper starting with 180 grit/mesh is used in the transverse direction of the subsequent main flow and then 80 grit/mesh in the longitudinal direction. Alternatively, coarser grits can be used. This depends in particular on the layer thickness of the catalytic coating (57) to be applied.

A catalytic noble coating (57) is to be melted (55% platinum and 45% rhenium) with a layer thickness of approx. 10 μm in this embodiment. The catalytic noble coating (57) is to be chemically activated by surface treatment with a pulsed laser (56). Craters (58) (1-10 μm long) and grooves (59) (approx. 100 μm long) are to be melted to a depth of 1 μm. The width of the craters (58) and the grooves (59) is 1 μm and the spacing is a few micrometers (1-5 μm).

Coking or fouling on the heterogeneous catalysts (1) is counteracted by the additional homogeneous catalysts (2) to be injected.

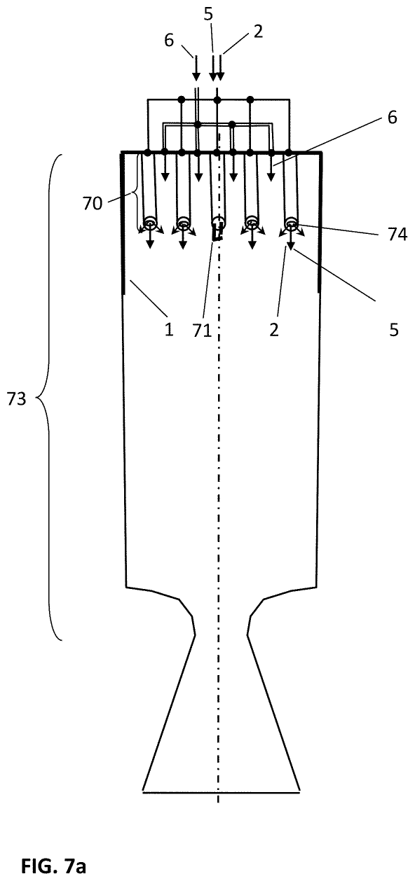

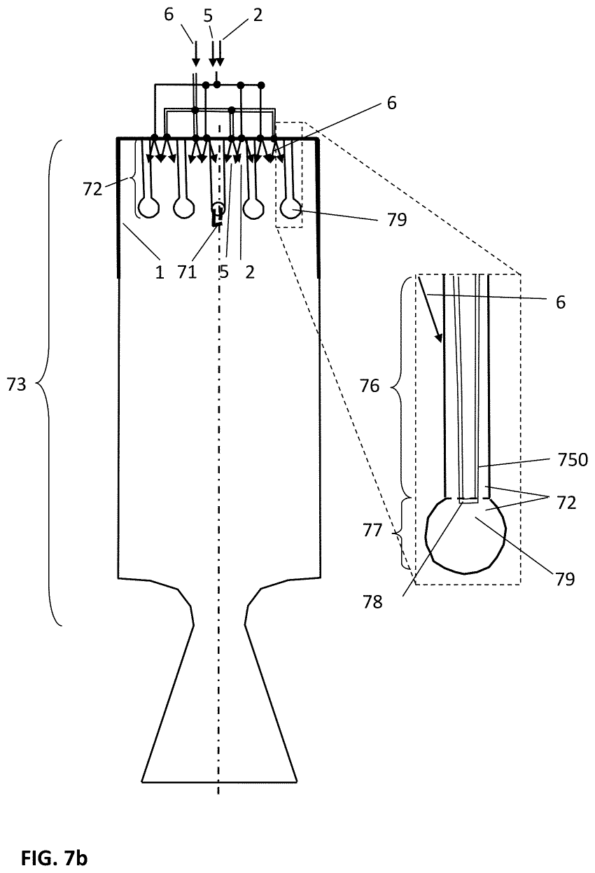

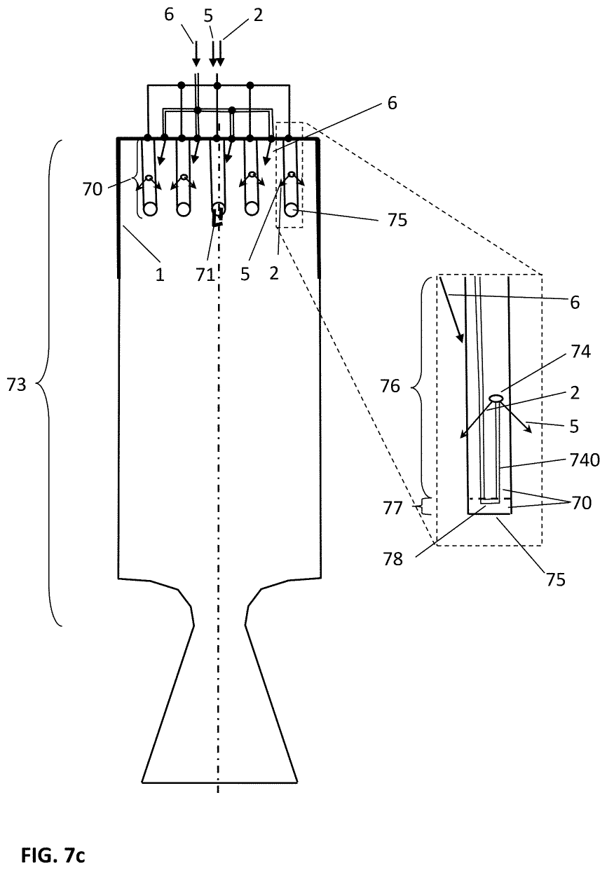

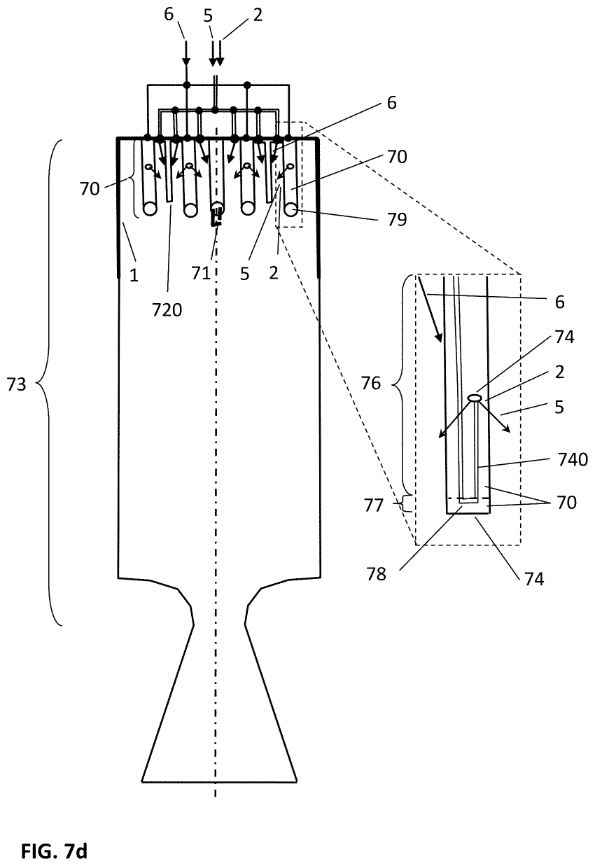

FIG. 7a: Engine System (Rocket): Elongated Arrangement, Oxidizer

In this embodiment, an engine system with elongated catalysts (70) is shown.

Due to reactive cooling, injection occurs at elevated temperature and in the heated combustion chamber (73). Nevertheless, to initiate the reaction and increase the reaction rate in the startup phase, additional igniters (71) are arranged between the stretched catalysts (70). The stretched catalysts (70) are distributed over the cross section of the combustion chamber (73). Together with the heterogeneous catalysts (1) of the wall coating, these form the heterogeneous catalysts.

To achieve the greatest possible catalytic activity by contact with fresh mass flow, the heterogeneous catalysts (1+70) are placed in the initial region of the combustion chamber (73) of a conventional rocket engine system. This region has the greatest reaction potential and closest proximity to the conversion. In addition, dissociation downstream of the combustion chamber (73) can be detrimental to the energy balance (additional endothermic decomposition). Free binding partners can thus enter into reaction immediately in the initial region and the reaction temperature can be lowered.

The earliest possible contact and effectiveness are made possible directly in the region of the combustion reaction. This area is located at the injection point of the oxidizer (6) or reducing agent (5). Alternatively, the entire area of the combustion chamber (73) and nozzle can be catalytically coated (e.g. with gold, or chemically more resistant platinum alloys) for improved heat reflection.

The additional heterogeneous catalysts (70) are arranged in an elongated-stretched form in order to achieve the largest possible contact area with minimum possible flow resistance. Alternatively, a line for separate injection (74) of fuel components (5) can be operated via the elongated-stretched shape. Fuel components are e.g. H₂ or CH₄ or mixed-in homogeneous catalysts (2). In this case, the catalyst material can at the same time be cooled in a controlled manner via reactive cooling.

The base body of the heterogeneous catalysts (70) is roughened mechanically (medium and coarse grinding). For this purpose, diamond abrasive paper is used starting with 180 grit/mesh in the transverse direction of the subsequent main flow and then 80 grit/mesh in the longitudinal direction. Alternatively, coarser grits can be used. This depends in particular on the layer thickness of the catalytic coating to be applied. A catalytic noble coating is to be applied (55% platinum and 45% rhenium) with a layer thickness of approx. 100 μm.

The additional homogeneous catalysts (2) to be injected counteract coking or fouling on the heterogeneous catalysts (1+70).

FIG. 7b: Engine System (Rocket): Stretched Arrangement, Spray Plate

In contrast to FIG. 7a, in this embodiment the heterogeneous catalysts (72) are flowed against laterally by the reducing agent (5) and oxidizer (6). Compared with FIG. 7a, the heterogeneous catalysts (72) are formed with injection plates (79). The additional injection of FIG. 7a is missing. The heterogeneous catalysts (72) are provided with a cooling loop for reactive cooling.

Pipes (740) are drilled into the base bodies of the heterogeneous catalysts (72) as cooling loops.

FIG. 7c: Engine System (Rocket): Stretched Arrangement

In contrast to FIG. 7a, in this embodiment the heterogeneous catalysts (70) are flowed against laterally by the reducing agent (5) and oxidizer (6). Pipes (740) are drilled into the base bodies of the heterogeneous catalysts (70) as cooling loops. A transverse line (78) is milled into the front end (74). The upper (76) and lower halves (77) of the heterogeneous catalysts (70) are joined, e.g. by welding.

The additional injection (74) takes place laterally to achieve a better uniformity of injection.

FIG. 7d: Thruster system (rocket): stretched arrangement, mix plate Like FIG. 7c. However, additional mixplates (720) are arranged between the stretched heterogeneous catalysts (72). Reducing agent (5) and oxidizer (6) flow onto the 1465 mixplates (720). The mixplates (720) in the core of molybdenum are catalytically coated with a platinum-rhenium alloy (55% platinum and 45% rhenium). The core of the mixplates and the catalytic coating are constructed as described in FIG. 7a (approx. 100 μm layer thickness, vertical sections).

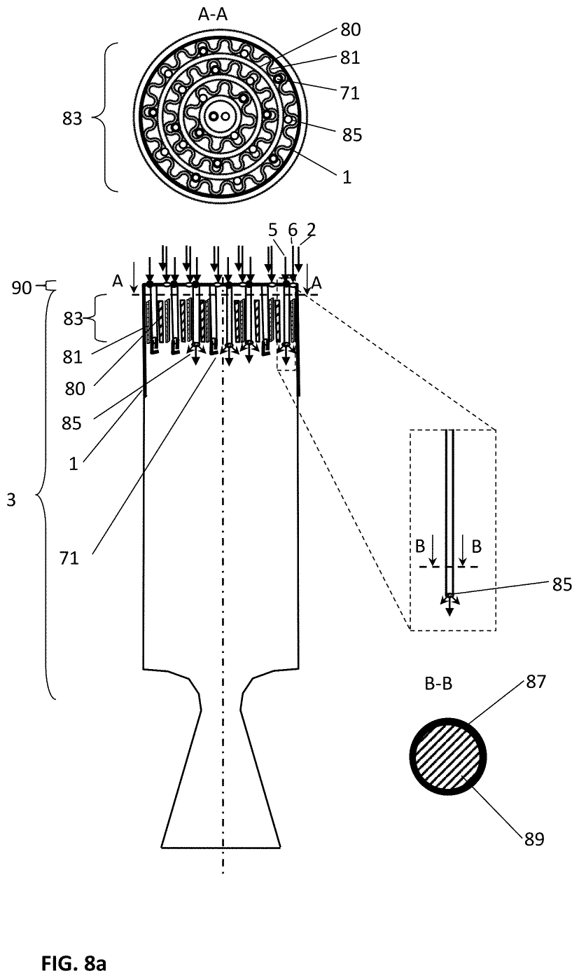

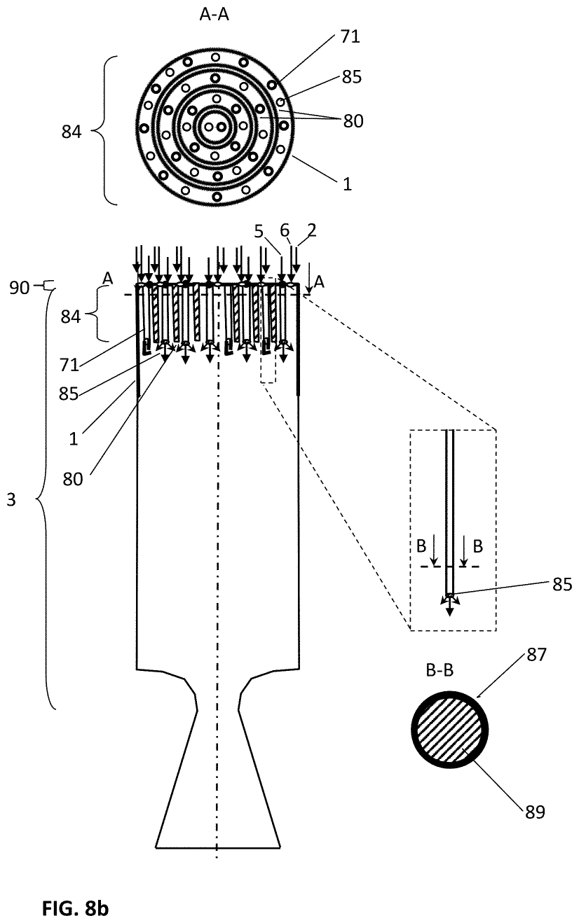

FIG. 8a: Engine System (Rocket): Honeycomb Structure, Multi-Stage

In this embodiment, a heterogeneous catalyst is formed from catalytic wall coating (1) on part of the combustion chamber (3) and from a honeycomb base structure (83) in the initial region of the combustion chamber (3).

In order to produce a mechanically suitable, sufficiently chemically resistant and catalytically effective honeycomb base structure (83), ring plates (80) and corrugated plates (81) must be joined together. The corrugated sheets (81) have a round shape to provide a larger contact area when flow passes through them. The sheets (80+81) are aligned perpendicular to the direction of flow in the combustion chamber (3). The honeycomb structure is formed by concentric arrangement and bonding (83).

The core (89) of these sheets (80+81) is made of molybdenum. The ring plates (80) and corrugated plates (81) are catalytically coated on both sides (87).

The honeycomb structure (83) can be connected to the head plate (90) of the combustion chamber (3) at the outer injection nozzles (85). This provides an opportunity for reactive cooling. The sheets (80+81) are thermally welded or brazed at the contact points. The sheets (80 and 81) are made in a thickness which withstands the accelerated reaction of the reducing agent (5) and oxidizer (6).

The head plate (90) also has internal injection nozzles for oxidizer (6) and homogeneous catalysts (2). Reducing agent is injected in lean proportion at the inner injection nozzles of the head plate (90). At the honeycomb structure (83), lean is burned in the combustion chamber (3) in a first stage. Downstream, the fuel is further burned by further injection from the outer injection nozzles (85). This staged combustion allows combustion pressure, temperature and speed to be strongly regulated.

The sheets (80+81) and the outer injectors (85) consist of a core (89) and a catalytic coating (87) with an applied thickness of approx. 10 μm of platinum-rhenium (approx. 55% platinum and 45% rhenium). Alternatively, an alloy with other proportions of platinum and rhenium is possible.

Igniters (71) are regularly arranged in the free spaces to start the reaction or to accelerate the reaction in the start phase. The activity of the heterogeneous catalysts (1+83) increases with rising temperature. The igniters (71) can be partially, or if necessary completely, deactivated during operation. The outer injectors (85) can alternatively be additionally wrapped with catalytic fabric. However, this has been dispensed with in this embodiment.

The additional homogeneous catalysts (2) to be injected counteract coking or possible fouling on the honeycomb structure (83)−formed by sheets (80+81) and heterogeneous catalyst (1).

FIG. 8b: Engine System (Rocket): Concentric Arrangement, Multistage

Compared to FIG. 8a, the corrugated sheets (81) are omitted in this embodiment. This embodiment thus shows another possible basic structure (84) of heterogeneous catalysts with wall coating (1) and circular sheets (80).

Separate injection nozzles (85) for reactive cooling of the catalytic structure (84) are arranged analogously in the free spaces.

This arrangement, analogous to FIG. 8a, enables staged combustion.

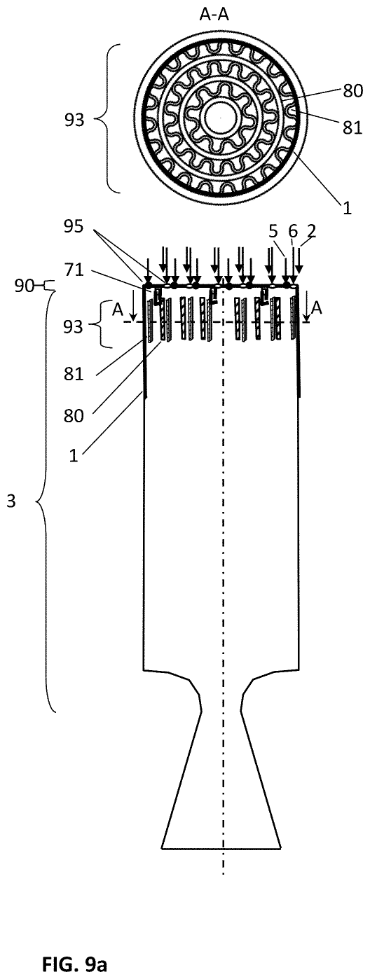

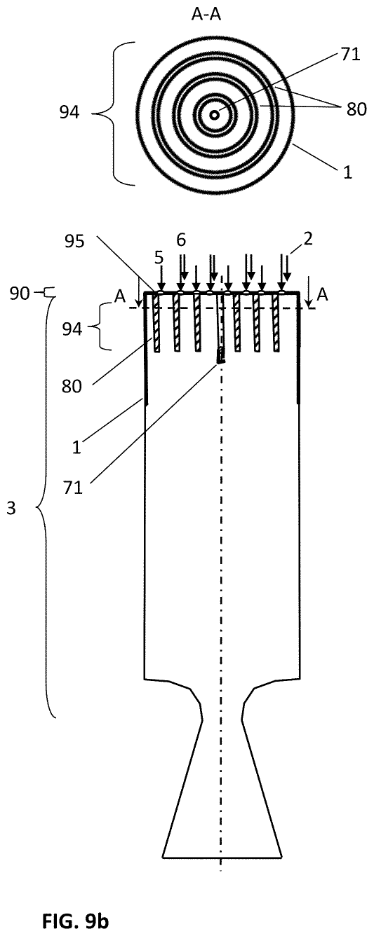

FIG. 9a: Engine System (Rocket): Honeycomb Structure, Single-Stage

Compared to the design variant in FIG. 8a, the separate nozzles are omitted in this FIG. The nozzles (95) are installed exclusively at the head flap (90). The honeycomb structure (93) is attached to the walls of the combustion chamber (3). Reactive cooling can optionally be supplemented via the walls of the combustion chamber (3) by means of appropriate connections.

FIG. 9b: Engine system (rocket): concentric arrangement, single-stage Compared with the embodiment in FIG. 8b, the separate nozzles downstream of the heterogeneous catalysts are omitted in this FIG.. Injection takes place exclusively at the injector plate (90) via internal injection nozzles (95). Compared with FIG. 9a, the corrugated plates are missing and the concentric ring plates (80) are extended and connected to the head plate (90) to allow reactive cooling.

A heterogeneous catalyst with a concentric shape is formed (94)

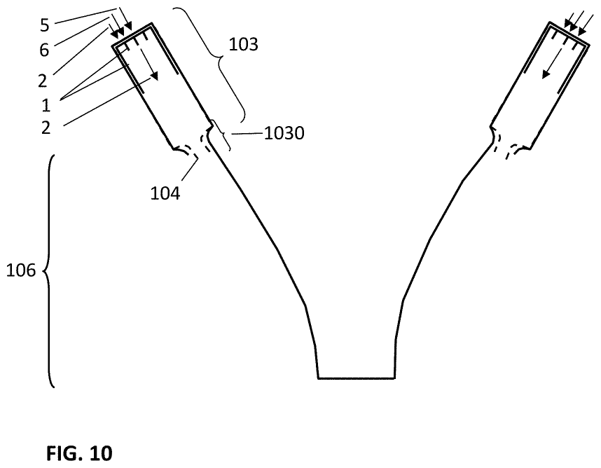

FIG. 10: Engine System (Aerospike): Reduced Constriction

In this embodiment, a scheme for use with aerospikes (106) is shown.

The combustion chamber (103) is designed with a reduced necking (1030), compared with similar aerospikes (104). This can be achieved, for example, by increased speed of injection due to higher reaction speed during combustion. The necking of the combustion chamber of comparable aerospikes (104) is indicated. Reducing agent (5) and oxidizer (6) are injected into the combustion chamber (103).

The heterogeneous (1) and homogeneous catalysts (2) influence the temperature and pressure of the reaction and allow a higher reaction rate in the combustion chamber (103). This has further advantages for cooling. The heat dissipation, or cooling, can be distributed over a larger cross-sectional area compared to other aerospikes. In addition, friction is reduced, which means further positive secondary effects for the heat balance of the combustion chamber (103).

The additional homogeneous catalysts (2) to be injected counteract coking or fouling on the heterogeneous catalysts (1) of the combustion chamber (103).

At higher injection speeds, supplied mass flows, a tubular or conical combustion chamber shape is also possible.

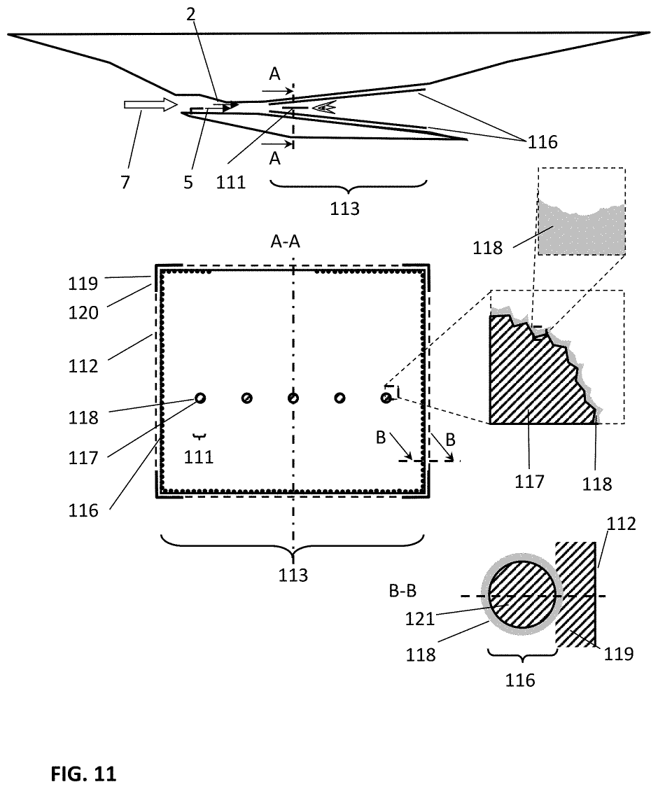

FIG. 11: Engine System (Scramjet): Partial Coating

In this embodiment, an air-breathing engine with supersonic combustion is shown (scramjet).

According to the state of the art, scramjets are designed to be as streamlined as possible in order to generate the greatest possible net thrust. Therefore, the installation of additional geometries for heterogeneous catalysts is energetically challenging. Therefore, only absolutely necessary geometries are provided with catalytic coating (118).

Catalytically coated (118) burners (111) and, if necessary, riblets (116) are provided in the combustion chamber (113), as well as in corner areas (120). To improve the flow properties, riblets (116) corresponding to a sharkskin are suitable at the boundaries of the flow channel to react catalytically with the air mass flow (7) and the reducing agent (5), or fuel. Alternatively, dimples are also possible (analogous to the surface of golf balls).

The base body (117) of the heterogeneous catalysts is made of molybdenum. In the area of the burners (111), the base body (117) is mechanically roughened (medium and coarse grinding) for the catalytic coating (118). For this purpose, abrasive paper starting with 180 grit/mesh is used in the transverse direction of the subsequent main flow and then 80 grit/mesh is used in the longitudinal direction. Alternatively, coarser grits can be used. This depends in particular on the layer thickness of the catalytic coating (118) to be applied. A catalytic noble coating (118) is to be applied (55% platinum and 45% rhenium) with a layer thickness of e.g. approx. 100 μm. The catalytic coating (118) is to be chemically activated by surface treatment using a pulsed laser. With a depth of 1-10 μm, grooves (approx. 100 μm) and craters (1-10) are to be melted.

The core of the riblets (116) in the combustion chamber (113) consists of molybdenum fibers (121) with a layer thickness of approx. 40 μm. A catalytic noble coating (118) of a platinum-rhenium alloy is applied to this (approx. 55% platinum and 45% rhenium). The layer thickness of the noble alloy is approx. 5 μm. The spacing of the riblets (116) is approx. 50 μm. The riblets (116) are attached to the outer walls (112) of the combustion chamber (113) on a support mat or support sheet (119). The material consists of molybdenum, for example.

Additional catalytic layers (118) are applied in the corners or gussets (120) of the combustion chamber (113). In these corners (120), turbulence is created by the transitions from insulator to combustion chamber (113), or by the capstan mass flow partially continuing from the inlet. Combustion of the air mass flow in this area is challenging. To increase the burnout of the air mass flow (7), or of the reducing agent (5), a catalytic coating (118) beyond the riblets in these corners (120) is advantageous. A catalytic noble alloy (118) is applied to the carrier mat/carrier sheet (119) made of molybdenum. This catalytic platinum-rhenium alloy (platinum 55%, rhenium 45%) has a layer thickness of approx. 100 μm. In the embodiment, one tenth of the side length of each combustion chamber (113) must be additionally coated. The riblets (116) are attached to the backing sheet (119) by laser or other thermal processes.

The additional homogeneous catalysts (2) to be injected counteract coking or fouling on the catalytic coating (118).

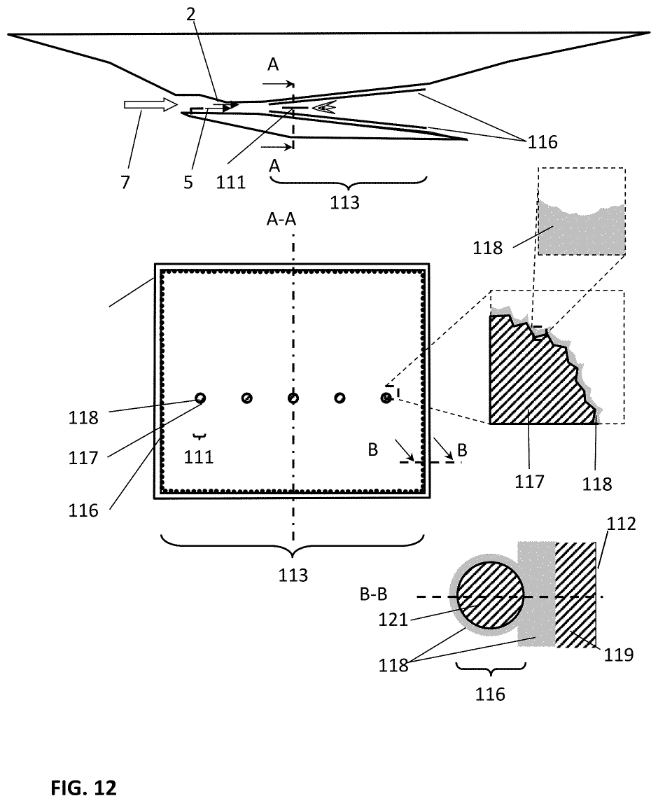

FIG. 12: Engine System (Scramjet): Complete Coating

In contrast to the designs in FIG. 11, the entire combustion chamber (113), i.e. the entire outer walls (112) from the combustion chamber (113) onward, is catalytically coated. This is intended to increase the burnout of the air mass flow (7), or of the reducing agent (5). Since a noble coating (118) is also applied under the riblets (116), the coating is highly durable. When riblets (116) detach, the additional catalytic coating (118) of the combustion chamber (113) is exposed.

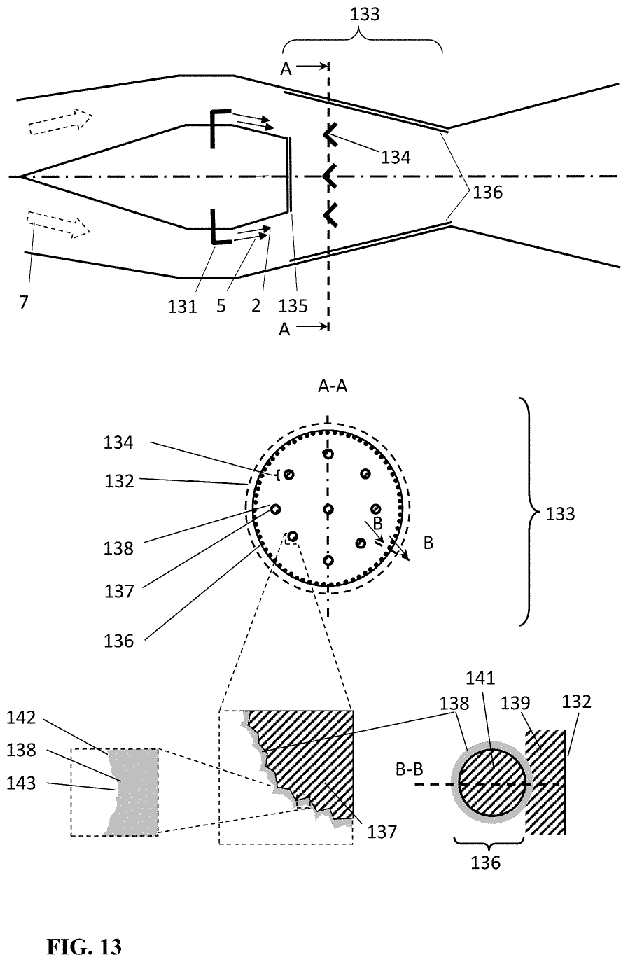

FIG. 13: Engine System (Ramjet): Partial Coating

This variant shows an air-breathing engine with subsonic combustion (Ramjet). A concentric engine geometry with annular combustion chamber is shown.

In principle, Ramjets are also designed to be as streamlined as possible in order to generate the greatest possible net thrust. Therefore, the installation of additional geometries for catalytic coatings (138) is energetically disadvantageous. Therefore, only necessary geometries are designed catalytically and, if necessary, extended.

The fuel (5) and the homogeneous catalysts (2) reach the incoming air mass flow (7) via the injection (131). In this embodiment of the Ramjet, a catalytic coating (138) is arranged on the burners (134) and in the region of the combustion chamber (133) on the riblets (136) and in edge regions (135).

The carrier layer or base body (137) is made of molybdenum or a molybdenum alloy. Alternatively, other metals and alloys are also possible (e.g. iron/nickel alloys, vanadium alloys, tungsten/tungsten alloys). In the area of the burners (134), the base bodies (137) of the catalytic coating (138) are roughened mechanically (medium and coarse grinding). For this purpose, diamond abrasive paper starting with 180 grit/mesh is used in the transverse direction of the subsequent main flow and then 80 grit/mesh is incorporated in the longitudinal direction. Alternatively, coarser grits can be used. This depends in particular on the layer thickness of the catalytic coating (138) to be applied subsequently.

A catalytic noble coating (138) (55% platinum and 45% rhenium) with a layer thickness of 100 μm is to be applied to it. The coating is to be chemically activated by surface treatment with a pulsed laser. With a depth of 1-10 μm, craters (142), ≤1 μm and grooves (143) approx. ≤100 μm in length shall be thermally incorporated.

Riblets (136) of molybdenum fibers with an inner layer thickness or core (141) of approx. 40 μm are used in the combustion chamber (133). A catalytic noble coating (138) of a platinum-rhenium alloy is fused onto the molybdenum fibers (approx. 55% platinum and 45% rhenium). The layer thickness of the noble alloy (138) is approx. 5 μm in this area. The total diameter of the riblets (136) is thus approx. 50 μm each. The riblets (136) are arranged in a grid of approx. 100 μnm, or approx. 50 μm apart in each case. The riblets (136) are attached to the outer walls (132) of the combustion chamber (133) on a support mat or support plate (139). The material is molybdenum.

A catalytic noble alloy (138) is applied to the carrier mat/carrier sheet (139) made of molybdenum. A catalytic platinum-rhenium alloy (platinum 55%, rhenium 45%) with a layer thickness of approx. 100 μm is used for this purpose.

The additional homogeneous catalysts (2) to be injected counteract coking or fouling on the catalytic coating (138).

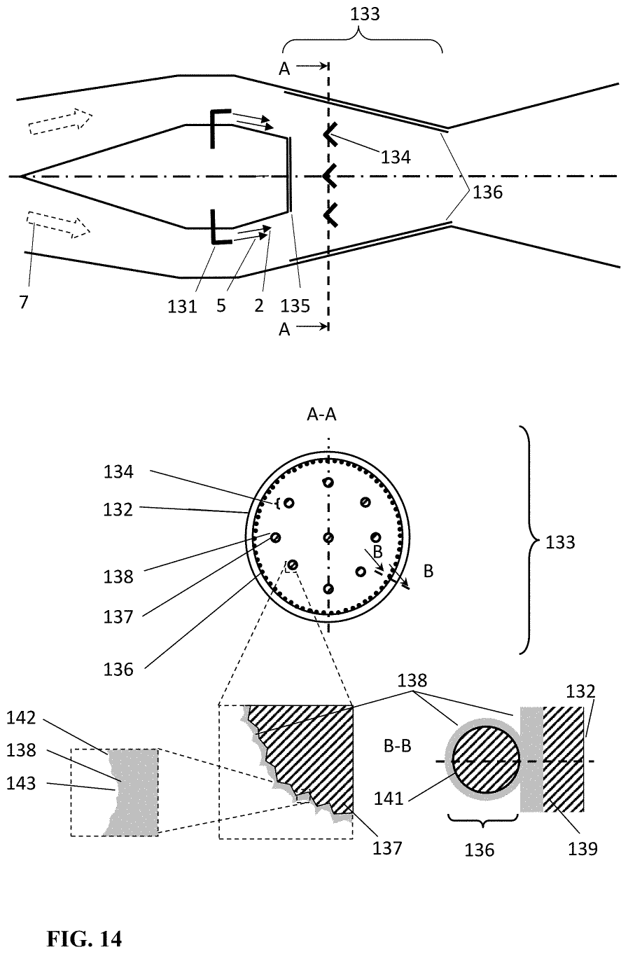

FIG. 14: Engine System (Ramjet): Complete Coating

In contrast to the designs in FIG. 13, in this embodiment the support mat (139) in the combustion chamber (133) is catalytically coated (138). This is intended to increase the burnout of the air mass flow (7) and the reducing agent (5) to the maximum. A catalytic noble coating (138) of a platinum-rhenium alloy (platinum 55%, rhenium 45%) with a layer thickness of approx. 100 μm is used. The noble coating (138) is applied to a carrier mat/carrier sheet (139) made of molybdenum.

Since a noble coating (138) is also applied under the riblets (136), there is a high degree of durability because further catalytic layers are exposed when the riblets (136) are detached.

The additional homogeneous catalysts (2) to be injected counteract coking or fouling on the catalytic coating (138).

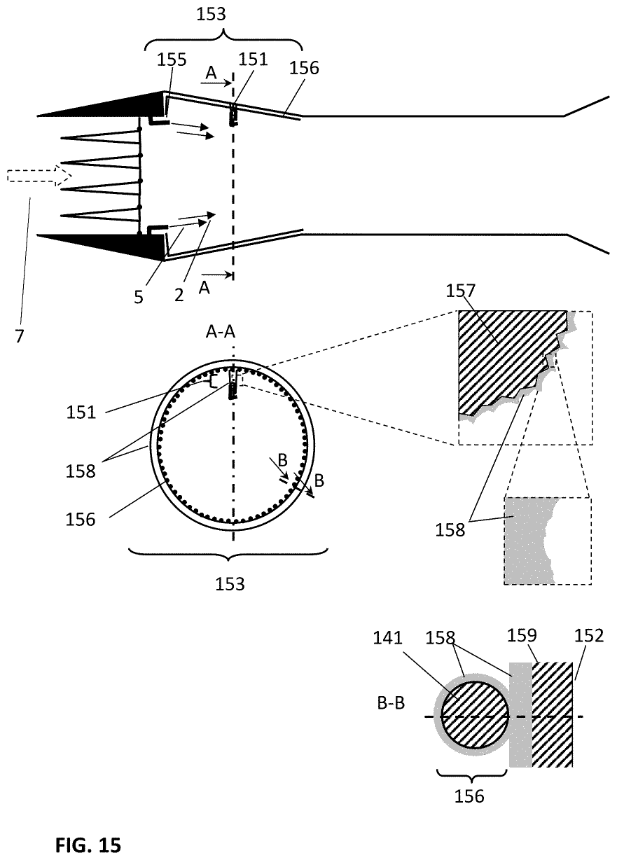

FIG. 15: Engine System (Pulse Jet Engine)

In this embodiment, an air-breathing engine with pulsating combustion is shown (pulsejet engine).

In the pulsejet engine, a catalytic coating (158) is applied to the burners (151) and in the combustion chamber (153), or riblets (156). The burnout of the air mass flow (7) and the utilization of the reducing agent (5) are thus to be increased. Residues from incomplete combustion and unburned components, in particular due to the short combustion times, are to be minimized.

In the area of the igniter (151) and the combustion chamber (153), the base body (157) of the catalytic coating (158) is roughened mechanically (medium and coarse grinding). For this purpose, abrasive paper starting with 180 grit/mesh is used in the transverse direction of the subsequent main flow and then 80 grit/mesh in the longitudinal direction. Alternatively, coarser grits can be used. This depends in particular on the layer thickness of the catalytic coating (158) to be applied.

In the area of the igniter (151) and the combustion chamber (153), the base body (157) of the catalytic coating (158) is roughened mechanically (medium and coarse grinding). For this purpose, abrasive paper starting with 180 grit/mesh is used in the transverse direction of the subsequent main flow and then 80 grit/mesh in the longitudinal direction. Alternatively, coarser grits can be used. This depends in particular on the layer thickness of the catalytic coating (158) to be applied.

The additional homogeneous catalysts (2) to be injected counteract coking or fouling on the catalytic noble coating (158).

What is claimed is:

1. A method of catalytic or ternary reaction in liquid chemical engine systems involving combustion of at least one separate oxidizer of oxygen or atmospheric oxygen (e.g., rocket engine systems, supersonic rocket combustors, detonation engines, gas turbines, resp. gas turbines for turbopumps), air-breathing engine systems (e.g., pulse jet engines, subsonic ramjets, ramjets, dualmode ramjets, scramjets, detonation engines, combination engines) comprising:
addition of at least one of the following two additives homogeneous catalysts (2) or metallic additives versus combustion without at least one of said additives in said engine systems to influence at least one of the following process parameters: Combustion chamber temperature, combustion chamber pressure, maximum possible mass flow with sufficient combustion, pressure levels in the direction of flow, pressure levels perpendicular to the direction of flow, temperature levels in the direction of flow, temperature levels perpendicular to the direction of flow, minimum required mass flow, maximum possible spatial velocity of the mass flow at the beginning of the combustion chamber, transport of latent heat, superadiabatic combustion chamber conditions, and in addition to the previously named process parameters and notwithstanding a changed combustion chamber length in connection with the design of at least one of the following system parameters: Combustion chamber width, combustion chamber cross-section, inclinations of combustion chamber boundaries such as constrictions/expansions at nozzles, nozzle lengths, nozzle inclination.

2. A method according to claim 1 comprising:
in that the homogeneous catalysts (2) or metallic additives are introduced into the combustion chamber in at least one of the forms mentioned: comprising more than twice the length to the diameter, fibrous, in fiber structure, in fiber composite.

3. A system according to claim 1 comprising:
characterized in that the homogeneous catalysts consist of at least one of the following elements or at least one alloy of any of the following elements: Iron, nickel, cerium, copper, vanadium, molybdenum, platinum group metals, elements of the IV, V, VI, VII, VIII, I and II subgroups.

4. A method according to claim 1 comprising:
characterized in that the input of the homogeneous catalysts (2), or metal particles, is changed during the reaction in at least one of the following properties: in material concentration or location of the input in order to adjust process parameters of the combustion, such as adjusting the pressure at the nozzle outlet to the ambient pressure (e.g. for vertical starts), or, for example, to support the combustion outside the control operation of the engine system (e.g. in start-up phase, combustion completion phase).

5. A method according to claim 1 comprising:
in that the homogeneous catalysts (2) are introduced into the combustion chamber with at least one of the following properties relative to at least one of the other fuel components: increased injection speed, changed injection temperature, changed concentration along the combustion chamber cross-section, or changed injection location along the combustion chamber axis.

6. A method according to claim 1 comprising:
characterized in that the homogeneous catalysts (2) are introduced into the combustion chamber with at least one of the following properties: in a liquid solution, in a solution of alcohol, with substances which are used as anti-knocking agents in combustion engines, with substances which reduce pressure fluctuations during combustion, substances which cause an ignition delay, in a solution together with anti-icing agents, in a solution together with anti-flocculating agents, in a solution together with dispersing agents, dispersed in a solution with an ignition delay, dispersed in a wax, dispersed in paraffin.

7. A method according to claim 1 comprising:
characterized in that homogeneous catalysts (2) having at least one of the following parameters are introduced with respect to each other: Different photo-catalytic properties, Different paramagnetic properties, Different ferromagnetic properties, Composite of homogeneous catalysts (2) of different photo-catalytic effects, Composite of homogeneous catalysts (2) of different paramagnetic properties, Composite of homogeneous catalysts (2) of different ferromagnetic properties, Alloy of homogeneous catalysts (2) of different photo-catalytic effects, Alloy of homogeneous catalysts (2) of different paramagnetic properties, Alloy of homogeneous catalysts (2) of different ferromagnetic properties.

8. A method according to claim 1 comprising:
in that heterogeneous catalysts (1) are used in the combustion chamber.

9. A system according to claim 1 comprising:
characterized in that the surface of the base for coating with heterogeneous catalysts (1) is structured by at least one of the following methods: mechanical methods, multiple mechanical methods, electromagnetic methods, multiple electromagnetic methods.

10. A system according to claim 1 comprising:
characterized in that, the surface of the heterogeneous catalysts (1) is structured by at least one of the following methods: mechanical methods, multiple mechanical methods, electromagnetic methods, multiple electromagnetic methods.

11. A system according to claim 1 comprising:
characterized in that the catalytic coating of at least a part of the combustion chamber is designed with at least one of the following geometrical characteristics: projecting notches of inclined partial surfaces to the cross-section of the combustion chamber, curves, of inclined partial surfaces to the cross-section of the combustion chamber, projecting surfaces of uniform inclination to the cross-section of the combustion chamber, variable size of the notches in, the flow direction of the combustion chamber, variable size of the curves in the flow direction of the combustion chamber, variable size of the surface in the flow direction of the combustion chamber.

12. A system according to claim 1 comprising:
characterized in that at least one heterogeneous catalyst (1) consists of at least one element having the following properties: element of the platinum group metals, elements of IV, V, VI, VII, VIII, I and II or subgroup.

13. A method according to claim 1 comprising:
in that the homogeneous catalysts (2) modify reaction residues or deposits on the heterogeneous catalysts (1) in at least one of the following ways: Avoidance, reduction, dissolution, conversion.

14. A method according to claim 1 comprising:
characterized in that a predominantly supersonic combustion in terms of energy is brought about in a targeted manner by multistage combustion in the combustion chamber or the nozzle.

15. An apparatus system according to claim 1 comprising:
characterized in that dimples with a catalytic coating are present in the combustion chamber.

16. An apparatus according to claim 1 comprising:
in that riblets with a catalytic coating are present in the combustion chamber.

17. An apparatus according to claim 1 comprising:
characterized in that the heterogeneous catalysts (1) are reactively cooled by at least one of the following: contained cooling loops, contained injection nozzles for common combustion, contained injection nozzles for downstream combustion.
